(19) United States
(12) Patent Application Publication
(10) Pub. No.: US 2026/0213793 A1
(43) Pub. Date: Jul. 23, 2026

(54) TECHNIQUES FOR SHARING RECONFIGURABLE INTELLIGENT SURFACES AMONG MULTIPLE TRANSMISSION-RECEPTION POINTS

(71) Applicant: QUALCOMM Incorporated, San Diego, CA (US)

(72) Inventors: Min HUANG, Beijing (CN); Chao WEI, Beijing (CN); Hao XU, Beijing (CN)

(21) Appl. No.: 19/140,247

(22) PCT Filed: Feb. 27, 2023
(86) PCT No.: PCT/CN2023/078337

§ 371 Date: Jun. 17, 2025

(51) Int. Cl. H04B 7/04; H04W 72/232

(52) U.S. Cl. CPC H04B 7/04013; H04W 72/232

(57) ABSTRACT

Methods, systems, and devices for wireless communications are described. A reconfigurable surface may be configured to transmit capability information indicating a capability of the reconfigurable surface to re-fleet a set of signals during overlapping time intervals in accordance with a corresponding set of different reflection parameter sets. The reconfigurable surface may receive one or more control messages indicating at least a first reflection parameter set and a second reflection parameter set for reflecting signals received from a first transmission-reception point (TRP) and a second TRP, respectively, during overlapping time intervals. The reconfigurable surface may then reflect a first signal received from the first TRP within a first time interval using the first reflection parameter set, and reflect a second signal received from the second TRP within a second time interval that at least partially overlaps with the first time interval using the second reflection parameter set.

### CROSS REFERENCE

The present Application is a 371 national phase filing of International PCT Application No. PCT/CN2023/078337 by HUANG et al., entitled “TECHNIQUES FOR SHARING RECONFIGURABLE INTELLIGENT SURFACES AMONG MULTIPLE TRANSMISSION-RECEPTION POINTS,” filed Feb. 27, 2023, which is assigned to the assignee hereof, and which is expressly incorporated by reference in its entirety herein.

### FIELD OF TECHNOLOGY

The following relates to wireless communications, including techniques for sharing reconfigurable intelligent surfaces (RISs) among multiple transmission-reception points (TRPs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications utilize reconfigurable intelligent surfaces (RISs) to increase throughput and increase quantities of wireless devices (e.g., UEs) which are able to connect with the network. RISs may include multiple reflective surface elements that enable the RISs to relay (e.g., reflect) transmissions between the base station and UEs.

### SUMMARY

The described techniques relate to improved methods, systems, devices, and apparatuses that support techniques for sharing reconfigurable intelligent surfaces (RISs) among multiple transmission-reception points (TRPs). Generally, aspects of the present disclosure are directed to techniques that enable RISs to relay communications according to multiple different reflection configurations at the same time. In particular, aspects of the present disclosure may support signaling that enables a single RIS to reflect communications received from multiple TRPs according to multiple different reflection configurations. For example, a RIS may receive control signaling that indicates multiple candidate reflection configurations that may be used by the RIS, and may subsequently receive one or more downlink control information (DCI) messages that indicate which of the candidate reflection configurations that are to be used by the RIS. Subsequently, the RIS may utilize the indicated candidate reflection configurations to reflect signals received within overlapping time intervals (e.g., simultaneous reflections) from multiple different TRPs.

A method is described. The method may include transmitting capability information indicating a capability of the reconfigurable surface to reflect a set of multiple signals during overlapping time intervals in accordance with a corresponding set of multiple different reflection parameter sets, receiving, based on the capability information, one or more control messages indicating at least a first reflection parameter set and a second reflection parameter set for reflecting signals received from a first TRP and a second TRP, respectively, during overlapping time intervals, reflecting a first signal received from the first TRP within a first time interval using the first reflection parameter set, and reflecting a second signal received from the second TRP within a second time interval that at least partially overlaps with the first time interval using the second reflection parameter set.

An apparatus is described. The apparatus may include a processor, memory coupled with the processor, and instructions stored in the memory. The instructions may be executable by the processor to cause the apparatus to transmit capability information indicating a capability of the reconfigurable surface to reflect a set of multiple signals during overlapping time intervals in accordance with a corresponding set of multiple different reflection parameter sets, receive, based on the capability information, one or more control messages indicating at least a first reflection parameter set and a second reflection parameter set for reflecting signals received from a first TRP and a second TRP, respectively, during overlapping time intervals, reflect a first signal received from the first TRP within a first time interval using the first reflection parameter set, and reflect a second signal received from the second TRP within a second time interval that at least partially overlaps with the first time interval using the second reflection parameter set.

Another apparatus is described. The apparatus may include means for transmitting capability information indicating a capability of the reconfigurable surface to reflect a set of multiple signals during overlapping time intervals in accordance with a corresponding set of multiple different reflection parameter sets, means for receiving, based on the capability information, one or more control messages indicating at least a first reflection parameter set and a second reflection parameter set for reflecting signals received from a first TRP and a second TRP, respectively, during overlapping time intervals, means for reflecting a first signal received from the first TRP within a first time interval using the first reflection parameter set, and means for reflecting a second signal received from the second TRP within a second time interval that at least partially overlaps with the first time interval using the second reflection parameter set.

A non-transitory computer-readable medium storing code is described. The code may include instructions executable by a processor to transmit capability information indicating a capability of the reconfigurable surface to reflect a set of multiple signals during overlapping time intervals in accordance with a corresponding set of multiple different reflection parameter sets, receive, based on the capability information, one or more control messages indicating at least a first reflection parameter set and a second reflection parameter set for reflecting signals received from a first TRP and a second TRP, respectively, during overlapping time intervals, reflect a first signal received from the first TRP within a first time interval using the first reflection parameter set, and reflect a second signal received from the second TRP within a second time interval that at least partially overlaps with the first time interval using the second reflection parameter set.

In some examples of the method, apparatuses, and non-transitory computer-readable medium described herein, receiving the one or more control messages may include operations, features, means, or instructions for receiving a single DCI message from the first TRP or the second TRP, where the single DCI message indicates the at least the first reflection parameter set and the second reflection parameter set, and where reflecting the first signal and the second signal may be based on receiving the single DCI message.

In some examples of the method, apparatuses, and non-transitory computer-readable medium described herein, receiving the one or more control messages may include operations, features, means, or instructions for receiving, from the first TRP, a first DCI message indicating the first reflection parameter set, where reflecting the first signal may be based on receiving the first DCI message and receiving, from the second TRP, a second DCI message indicating the second reflection parameter set where reflecting the second signal may be based on receiving the second DCI message.

Some examples of the method, apparatuses, and non-transitory computer-readable medium described herein may further include operations, features, means, or instructions for receiving control signaling indicating a maximum quantity of reflection parameter sets configurable at the reconfigurable surface for a single time interval, where the control signaling may be received based on the capability information.

Some examples of the method, apparatuses, and non-transitory computer-readable medium described herein may further include operations, features, means, or instructions for receiving control signaling indicating a set of multiple reflection parameter set identifiers associated with a set of multiple candidate reflection parameter sets, where the one or more control messages indicate a subset of the set of multiple reflection parameter set identifiers corresponding to at least the first reflection parameter set and the second reflection parameter set included within the set of multiple candidate reflection parameter sets.

Some examples of the method, apparatuses, and non-transitory computer-readable medium described herein may further include operations, features, means, or instructions for receiving, via the one or more control messages, an indication of a first set of resources associated with the first reflection parameter set and an indication of a second set of resources associated with the second reflection parameter set, where the first time interval and the second time interval may be associated with the first set of resources and the second set of resources, respectively.

Some examples of the method, apparatuses, and non-transitory computer-readable medium described herein may further include operations, features, means, or instructions for transmitting, via the capability information, an indication of a maximum quantity of reflection parameter sets supported by the reconfigurable surface during overlapping time intervals, where receiving the one or more control messages may be based on the indication of the maximum quantity of reflection parameter sets.

Some examples of the method, apparatuses, and non-transitory computer-readable medium described herein may further include operations, features, means, or instructions for transmitting, via the capability information, an indication of a set of multiple sub-surfaces associated with the reconfigurable surface, where each sub-surface of the set of multiple sub-surfaces may be configured to support a respective reflection parameter set during overlapping time intervals, where receiving the one or more control messages may be based on the indication of the set of multiple sub-surfaces.

Some examples of the method, apparatuses, and non-transitory computer-readable medium described herein may further include operations, features, means, or instructions for receiving, via the one or more control messages, an indication of a first sub-surface and a second sub-surface of the set of multiple sub-surfaces associated with the first reflection parameter set and the second reflection parameter set, respectively, where the first signal may be reflected using the first sub-surface, and where the second signal may be reflected using the second sub-surface.

Some examples of the method, apparatuses, and non-transitory computer-readable medium described herein may further include operations, features, means, or instructions for receiving, via control signaling, the one or more control messages, or both, a first set of one or more parameters associated with the first reflection parameter set and a second set of one or more parameters associated with the second reflection parameter set, where the first signal and the second signal may be reflected based on the first set of one or more parameters and the second set of one or more parameters, respectively, where the first set of one or more parameters, the second set of one or more parameters, or both, include a channel state information (CSI) reference signal (CSI-RS) resource identifier, a reflection codeword index, a reflection coefficient, a pair of incident and reflective direction angles, or any combination thereof.

Some examples of the method, apparatuses, and non-transitory computer-readable medium described herein may further include operations, features, means, or instructions for receiving control signaling indicating one or more control resource sets (CORESETs) associated with the reconfigurable surface and monitoring one or more search space sets associated with the one or more CORESETs, where receiving the one or more control messages may be based on the monitoring.

Some examples of the method, apparatuses, and non-transitory computer-readable medium described herein may further include operations, features, means, or instructions for receiving control signaling indicating a first radio network temporary identifier (RNTI) associated with a first type of control messages that indicate a single reflection parameter set, a second RNTI associated with a second type of control messages that indicate multiple reflection parameter sets, or both, where the one or more control messages may be each associated with one of the first type of control messages or the second type of control messages.

Some examples of the method, apparatuses, and non-transitory computer-readable medium described herein may further include operations, features, means, or instructions for receiving control signaling indicating a RNTI associated with both a first type of control messages that indicate a single reflection parameter set, and a second type of control messages that indicate multiple reflection parameter sets, where each of the one or more control messages indicate whether the respective control message may be associated with the first type of control messages or the second type of control messages.

In some examples of the method, apparatuses, and non-transitory computer-readable medium described herein, and the method, apparatuses, and non-transitory computer-readable medium may include further operations, features, means, or instructions for reflecting the first signal from the first network entity to a first wireless device using the first reflection parameter set and reflecting the second signal from the second network entity to the first wireless device, a second wireless device, or both, using the second reflection parameter set.

In some examples of the method, apparatuses, and non-transitory computer-readable medium described herein, the reconfigurable surface includes a set of multiple reflective surface elements and each of the first reflection parameter set and the second reflection parameter set includes a set of multiple precoders, a set of multiple reflection coefficients, or both, associated with at least a subset of the set of multiple reflective surface elements.

A method is described. The method may include receiving, from a reconfigurable surface, capability information indicating a capability of the reconfigurable surface to reflect a set of multiple signals during overlapping time intervals in accordance with a corresponding set of multiple different reflection parameter sets, transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP, and transmitting, to the reconfigurable surface, at least a first signal for reflection by the reconfigurable surface to a wireless device within the first time interval in accordance with the first reflection parameter set.

An apparatus is described. The apparatus may include a processor, memory coupled with the processor, and instructions stored in the memory. The instructions may be executable by the processor to cause the apparatus to receive, from a reconfigurable surface, capability information indicating a capability of the reconfigurable surface to reflect a set of multiple signals during overlapping time intervals in accordance with a corresponding set of multiple different reflection parameter sets, transmit, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP, and transmit, to the reconfigurable surface, at least a first signal for reflection by the reconfigurable surface to a wireless device within the first time interval in accordance with the first reflection parameter set.

Another apparatus is described. The apparatus may include means for receiving, from a reconfigurable surface, capability information indicating a capability of the reconfigurable surface to reflect a set of multiple signals during overlapping time intervals in accordance with a corresponding set of multiple different reflection parameter sets, means for transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP, and means for transmitting, to the reconfigurable surface, at least a first signal for reflection by the reconfigurable surface to a wireless device within the first time interval in accordance with the first reflection parameter set.

A non-transitory computer-readable medium storing code is described. The code may include instructions executable by a processor to receive, from a reconfigurable surface, capability information indicating a capability of the reconfigurable surface to reflect a set of multiple signals during overlapping time intervals in accordance with a corresponding set of multiple different reflection parameter sets, transmit, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP, and transmit, to the reconfigurable surface, at least a first signal for reflection by the reconfigurable surface to a wireless device within the first time interval in accordance with the first reflection parameter set.

In some examples of the method, apparatuses, and non-transitory computer-readable medium described herein, transmitting the one or more control messages may include operations, features, means, or instructions for transmitting a single DCI message to the reconfigurable surface, where the single DCI message indicates the first reflection parameter set and not the second reflection parameter set, and where transmitting the first signal may be based on transmitting the single DCI message.

In some examples of the method, apparatuses, and non-transitory computer-readable medium described herein, transmitting the one or more control messages may include operations, features, means, or instructions for transmitting, to the reconfigurable surface, a first DCI message indicating the first reflection parameter set, where transmitting the first signal may be based on transmitting the first DCI message and transmitting, to the reconfigurable surface, a second DCI message indicating the second reflection parameter set.

Some examples of the method, apparatuses, and non-transitory computer-readable medium described herein may further include operations, features, means, or instructions for transmitting, to the reconfigurable surface, control signaling indicating a maximum quantity of reflection parameter sets configurable at the reconfigurable surface for a single time interval, where the control signaling may be transmitted based on the capability information.

Some examples of the method, apparatuses, and non-transitory computer-readable medium described herein may further include operations, features, means, or instructions for transmitting control signaling indicating a set of multiple reflection parameter set identifiers associated with a set of multiple candidate reflection parameter sets, where the one or more control messages indicate a subset of the set of multiple reflection parameter set identifiers corresponding to the first reflection parameter set and the second reflection parameter set included within the set of multiple candidate reflection parameter sets.

Some examples of the method, apparatuses, and non-transitory computer-readable medium described herein may further include operations, features, means, or instructions for transmitting, via the one or more control messages, an indication of a first set of resources associated with the first reflection parameter set, where the first time interval may be associated with the first set of resources.

Some examples of the method, apparatuses, and non-transitory computer-readable medium described herein may further include operations, features, means, or instructions for receiving, via the capability information, an indication of a maximum quantity of reflection parameter sets supported by the reconfigurable surface during overlapping time intervals, where transmitting the one or more control messages may be based on the indication of the maximum quantity of reflection parameter sets.

Some examples of the method, apparatuses, and non-transitory computer-readable medium described herein may further include operations, features, means, or instructions for receiving, via the capability information, an indication of a set of multiple sub-surfaces associated with the reconfigurable surface, where each sub-surface of the set of multiple sub-surfaces may be configured to support a respective reflection parameter set during overlapping time intervals, where transmitting the one or more control messages may be based on the indication of the set of multiple sub-surfaces.

Some examples of the method, apparatuses, and non-transitory computer-readable medium described herein may further include operations, features, means, or instructions for transmitting, via the one or more control messages, an indication of a first sub-surface of the set of multiple sub-surfaces associated with the first reflection parameter set.

Some examples of the method, apparatuses, and non-transitory computer-readable medium described herein may further include operations, features, means, or instructions for transmitting, via control signaling, the one or more control messages, or both, a first set of one or more parameters associated with the first reflection parameter set, where the first set of one or more parameters includes a CSI-RS resource identifier, a reflection codeword index, a reflection coefficient, a pair of incident and reflective direction angles, or any combination thereof.

Some examples of the method, apparatuses, and non-transitory computer-readable medium described herein may further include operations, features, means, or instructions for transmitting control signaling indicating one or more CORESETs associated with the reconfigurable surface, where the one or more control messages may be associated with the one or more CORESETs.

Some examples of the method, apparatuses, and non-transitory computer-readable medium described herein may further include operations, features, means, or instructions for transmitting control signaling indicating a first RNTI associated with a first type of control messages that indicate a single reflection parameter set, a second RNTI associated with a second type of control messages that indicate multiple reflection parameter sets, or both, where the one or more control messages may be each associated with one of the first type of control messages or the second type of control messages.

Some examples of the method, apparatuses, and non-transitory computer-readable medium described herein may further include operations, features, means, or instructions for transmitting control signaling indicating a RNTI associated with both a first type of control messages that indicate a single reflection parameter set, and a second type of control messages that indicate multiple reflection parameter sets, where each of the one or more control messages indicate whether the respective control message may be associated with the first type of control messages or the second type of control messages.

In some examples of the method, apparatuses, and non-transitory computer-readable medium described herein, the reconfigurable surface includes a set of multiple reflective surface elements and the first reflection parameter set includes a set of multiple precoders, a set of multiple reflection coefficients, or both, associated with at least a subset of the set of multiple reflective surface elements.

Some examples of the method, apparatuses, and non-transitory computer-readable medium described herein may further include operations, features, means, or instructions for receiving, from the second TRP, a message indicating the second reflection parameter set and transmitting, via the one or more control messages, an indication of the second reflection parameter set.

Some examples of the method, apparatuses, and non-transitory computer-readable medium described herein may further include operations, features, means, or instructions for transmitting, to the second TRP, a message indicating one or more RNTIs associated with control messages that indicate reflection parameter sets to the reconfigurable surface, where the one or more control messages may be associated with the one or more RNTIs.

Some examples of the method, apparatuses, and non-transitory computer-readable medium described herein may further include operations, features, means, or instructions for receiving, from the second TRP, a control message indicating one or more CORESETs associated with control messages communicated from the second TRP to the reconfigurable surface and transmitting, to the reconfigurable surface via control signaling, the one or more control messages, or both, an indication of the one or more CORESETs.

### BRIEF DESCRIPTION OF THE DRAWINGS

FIG. 1 illustrates an example of a wireless communications system that supports techniques for sharing reconfigurable intelligent surfaces (RISs) among multiple transmission-reception points (TRPs) in accordance with one or more aspects of the present disclosure.

FIG. 2 illustrates an example of a network architecture that supports techniques for sharing RISs among multiple TRPs in accordance with one or more aspects of the present disclosure.

FIG. 3 illustrates an example of a wireless communications system that supports techniques for sharing RISs among multiple TRPs in accordance with one or more aspects of the present disclosure.

FIG. 4 illustrates an example of a process flow that supports techniques for sharing RISs among multiple TRPs in accordance with one or more aspects of the present disclosure.

FIG. 5 illustrates an example of a process flow that supports techniques for sharing RISs among multiple TRPs in accordance with one or more aspects of the present disclosure.

FIGS. 6 and 7 illustrate block diagrams of devices that support techniques for sharing RISs among multiple TRPs in accordance with one or more aspects of the present disclosure.

FIG. 8 illustrates a block diagram of a communications manager that supports techniques for sharing RISs among multiple TRPs in accordance with one or more aspects of the present disclosure.

FIG. 9 illustrates a diagram of a system including a device that supports techniques for sharing RISs among multiple TRPs in accordance with one or more aspects of the present disclosure.

FIGS. 10 and 11 illustrate block diagrams of devices that support techniques for sharing RISs among multiple TRPs in accordance with one or more aspects of the present disclosure.

FIG. 12 illustrates a block diagram of a communications manager that supports techniques for sharing RISs among multiple TRPs in accordance with one or more aspects of the present disclosure.

FIG. 13 illustrates a diagram of a system including a device that supports techniques for sharing RISs among multiple TRPs in accordance with one or more aspects of the present disclosure.

FIGS. 14 through 17 illustrate flowcharts showing methods that support techniques for sharing RISs among multiple TRPs in accordance with one or more aspects of the present disclosure.

### DETAILED DESCRIPTION

Some wireless communications utilize reconfigurable intelligent surfaces (RISs) to increase throughput and increase quantities of wireless devices (e.g., user equipments (UEs)) which are able to connect with the network. RISs may include multiple reflective surface elements that enable the RISs to relay (e.g., reflect) transmissions between the base station and UEs. In this regard, RISs may provide for high beamforming gain for communications within the wireless communications system, and may enable a network entity to circumvent obstructions which would otherwise interrupt wireless communications.

Some RISs may include relatively simple devices that may or may not include a power source. Moreover, conventional RISs may be configured to relay communications in accordance with a single reflection configuration at any given time. That is, at any given time, a RIS may only be configured to reflect signals received from one transmission-reception point (TRP) according to a single reflection configuration, and may therefore be unavailable to relay signals from another TRP during that same time. Other RISs may have the capability to reflect multiple relay communications in accordance with multiple reflection configurations at a same time. However, methods and signaling for configuring the RISs for these multiple relay communications have yet to be defined or specified.

Accordingly, aspects of the present disclosure are directed to techniques that enable RISs to relay communications according to multiple different reflection configurations at the same time. In particular, aspects of the present disclosure are directed to signaling that enables a single RIS to reflect communications received from multiple TRPs according to multiple different reflection configurations. For example, a RIS may receive control signaling that indicates multiple candidate reflection configurations that may be used by the RIS, and may subsequently receive one or more downlink control information (DCI) messages that indicate which of the candidate reflection configurations that are to be used by the RIS. Subsequently, the RIS may utilize the indicated candidate reflection configurations to reflect signals received within overlapping time intervals (e.g., simultaneous reflections) from multiple different TRPs.

In some cases, the RIS may indicate capability information to the network, where the capability information indicates that the RIS is capable of supporting multiple simultaneous reflection configurations (e.g., the RIS can simultaneously reflect signals for multiple TRPs). In some cases, the RIS may receive a single DCI message that indicates multiple reflection configurations that are to be used. Conversely, in other cases, the RIS may receive multiple DCI messages (from the same or different TRPs), where each respective DCI message indicates a single reflection configuration to be used by the RIS.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to techniques for sharing RISs among multiple TRPs.

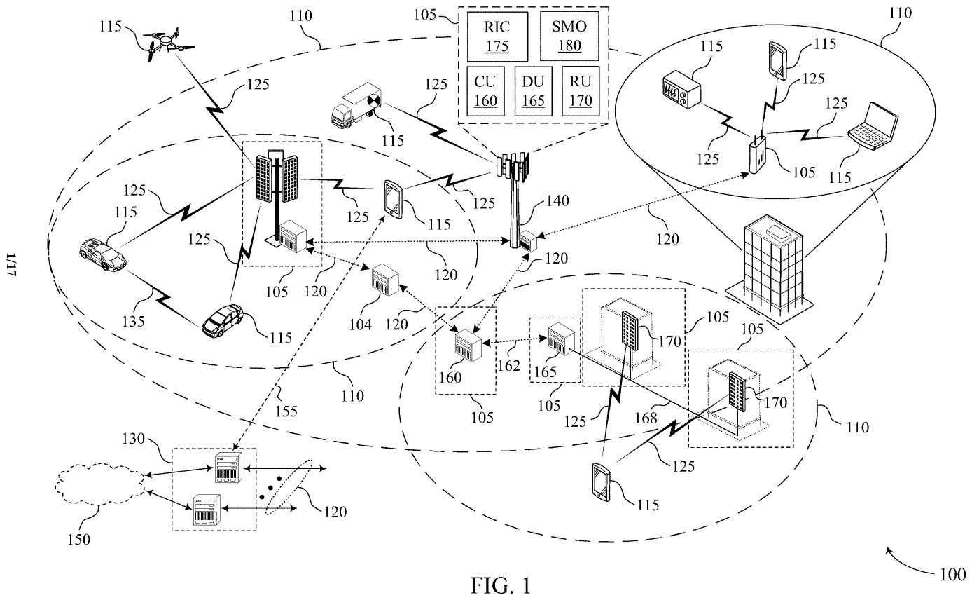

FIG. 1 illustrates an example of a wireless communications system 100 that supports techniques for sharing RISs among multiple TRPs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for sharing RISs among multiple TRPs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nr may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may include one or more RISs, and may support techniques that enable the RISs to relay communications according to multiple different reflection configurations at the same time. In particular, the wireless communications system 100 may support signaling that enables a single RIS to reflect communications received from multiple TRPs according to multiple different reflection configurations.

For example, a RIS of the wireless communications system 100 may receive control signaling (e.g., from a network entity 105) that indicates multiple candidate reflection configurations that may be used by the RIS, and may subsequently receive one or more DCI messages that indicate which of the candidate reflection configurations that are to be used by the RIS. Subsequently, the RIS may utilize the indicated candidate reflection configurations to reflect signals received within overlapping time intervals (e.g., simultaneous reflections) from multiple different TRPs. In other words, the RIS may reflect signals received from multiple TRPs of one or more network entities 105 to relay the signals to other devices in the wireless communications system 100, such as one or more UEs 115.

In some cases, the RIS may indicate capability information to the network, where the capability information indicates that the RIS is capable of supporting multiple simultaneous reflection configurations (e.g., the RIS can simultaneously reflect signals for multiple TRPs). In some cases, the RIS may receive a single DCI message that indicates multiple reflection configurations that are to be used. Conversely, in other cases, the RIS may receive multiple DCI messages (from the same or different TRPs), where each respective DCI message indicates a single reflection configuration to be used by the RIS.

Techniques described herein may enable RISs to simultaneously relay signals received from multiple TRPs in accordance with different reflection configurations. Accordingly, aspects of the present disclosure may be used to increase coverage and throughput associated with TRPs within a network, thereby leading to more efficient and reliable wireless communications. Moreover, techniques described herein may enable multiple TRPs to utilize a single RIS at the same time, thereby leading to more efficient and widespread use of RIS to further circumvent obstructions and improve data throughput.

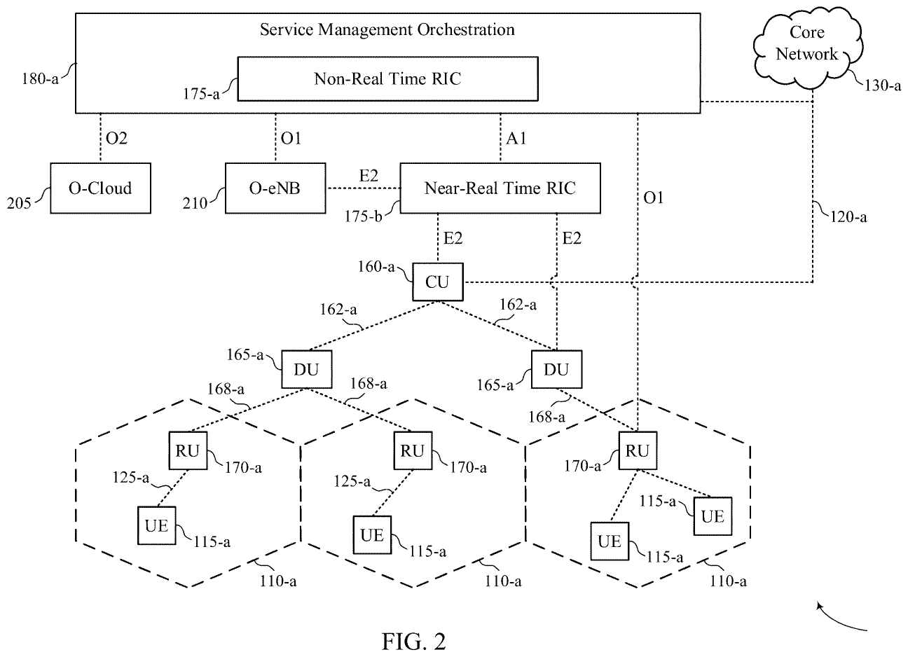

FIG. 2 illustrates an example of a network architecture 200 (e.g., a disaggregated base station architecture, a disaggregated RAN architecture) that supports techniques for sharing RISs among multiple TRPs in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

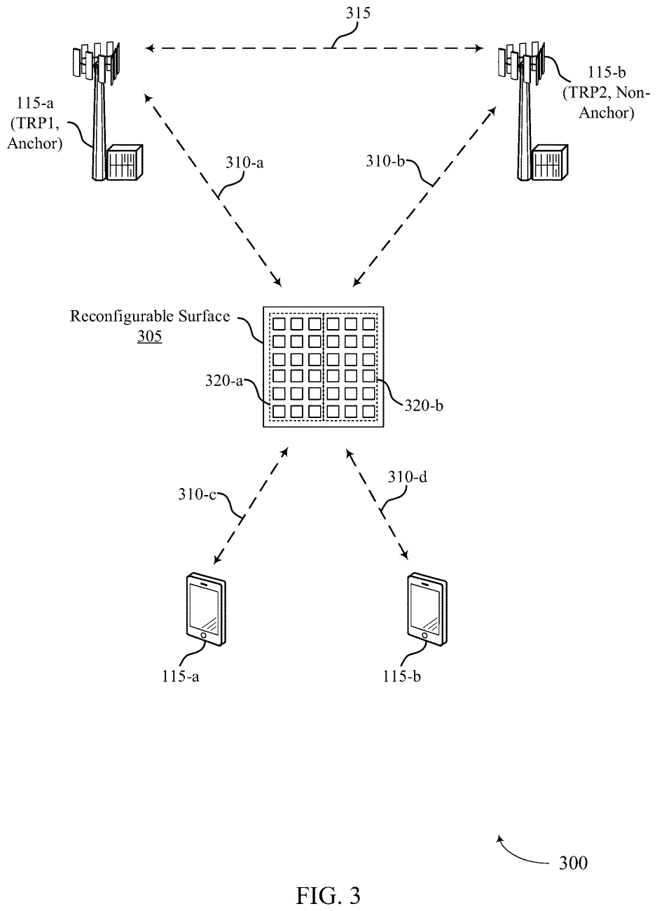

FIG. 3 illustrates an example of a wireless communications system 300 that supports techniques for sharing RISs among multiple TRPs in accordance with one or more aspects of the present disclosure. Aspects of the wireless communications system 300 may implement, or be implemented by, aspects of the wireless communications system 100, the network architecture 200, or both. For example, the wireless communications system 300 may support signaling that enables a single RIS to simultaneously reflect signals received from multiple TRPs, as described herein.

The wireless communications system 300 may include a first network entity 105-a (e.g., first TRP, TRP1), a second network entity 105-b (e.g., second TRP, TRP2), a reconfigurable surface 305 (e.g., RIS), a first UE 115-a, and a second UE 115-b, which may be examples of UEs 115, network entities 105, reconfigurable surfaces, and other wireless devices as described with reference to FIG. 1.

In some aspects, the first UE 115-a and the second UE 115-b may communicate with the respective network entities 105 via the reconfigurable surface 305. In particular, the reconfigurable surface 305 may be configured to relay (e.g., reflect) signals between the network entities 105 and the respective UEs 115 via a set of reflective surface elements. In particular, the reconfigurable surface 305 may be configured to reflect signals between the respective devices using one or more communication links. For example, the first network entity 105-a may communicate with the first UE 115-a via a communication link 310-a between the first network entity 105-a and the reconfigurable surface 305 and a communication link 315-c between the reconfigurable surface 305 and the first UE 115-a. Similarly, the second network entity 105-b may communicate with the second UE 115-b via a communication link 315-b between the second network entity 105-b and the reconfigurable surface 305 and a communication link 315-d between the reconfigurable surface 305 and the second UE 115-b.

In additional or alternative implementations, the reconfigurable surface 305 may relay communications between the first network entity 105-a and the second UE 115-b, between the second network entity 105-b and the first UE 115-a, or both. Moreover, in some aspects, the respective UEs 115 may be configured to communicate directly with the respective network entities 105 (e.g., without reflection facilitated by the reconfigurable surface 305). In such cases, the use of the reconfigurable surface may improve link diversity and/or throughput associated with communications between the respective UEs 115 and respective network entities 105. Further, the reconfigurable surface may be configured to exchange signaling with the respective network entities 105-a, 105-b via the communication links 310-a, 310-b.

In some cases, the communication links 310 may include examples of access links (e.g., a Uu links). The communication links 310 may include bi-directional links that can include both uplink and downlink communication. For example, the first UE 115-a may transmit uplink transmissions, such as uplink control signals or uplink data signals, to the first network entity 105-a via the reconfigurable surface 305 using the communication links 310-c and 310-a, and the first network entity 105-a may transmit downlink transmissions, such as downlink control signals or downlink data signals, to the first UE 115-a via the reconfigurable surface 305 using the communication links 310-a and 310-c.

As noted previously herein, some wireless communications systems may utilize reconfigurable surfaces 305 (e.g., active antenna units (AAUs), RISs) which are configured to relay (e.g., reflect) signals between other wireless devices. For the purposes of the present disclosure, the term “reconfigurable surface,” “RIS,” and like terms, may be used to refer to a wireless device that includes a surface with a large quantity of densely-placed reconfigurable meta elements (e.g., reflective surface elements) that are configured to reflect or refract electromagnetic waves (e.g., RF signals) in targeted directions. Such reconfigurable surfaces 305 may be used to increase throughput, improve beamforming gain, and circumvent obstructions to increase a quantity of UEs 115 which may be communicatively coupled to the network. For example, an obstruction may block, or otherwise interrupt, direct wireless communications between the first network entity 105-a and the first UE 115-a. In such cases, the reconfigurable surface 305 may be used to relay (e.g., reflect) signals between to circumvent the obstruction and facilitate communications between the respective devices.

Reconfigurable surfaces 305 may thereby improve a quality and reliability of wireless communications with relatively low cost and low power. The reconfigurable surface 305 may include a set of positive intrinsic-negative) diodes and/or varactor diodes, and may reflect signals with only control power, but no radiation power (e.g., reconfigurable surface 305 may not be configured to amplify reflected signals). In particular, some RISs may include relatively simple devices that may or may not include a power source. For example, in some cases, a reconfigurable surface 305 may not include its own power source, but may rather absorb power from received signals in order to reflect the respective signals.

The reconfigurable surface 305 may be configured to relay signals between respective devices by reflective means, transmissive means (e.g., refraction), or both (e.g., simultaneous reflection and refraction/transmission, such as a STAR RIS, hybrid RIS, omni-RIS, etc.). That is, the reconfigurable surface 305 may be configured to receive signals along a reception/incidence direction or angle, and reflect (or refract) the signals in a reflection direction or angle using some reflection configuration (e.g., set of precoders or reflection coefficients), where the incidence angle is different from the reflection angle.

Reflective beamforming performed by the reconfigurable surface 305 may be characterized or described by a general model and a far-field model. In the context of the general model, the reflection gain (h) of the reconfigurable surface may be defined according to Equation 1 below:

$$h = {Σ}_{n = 0}^{N - 1} {e}^{- j \frac{2 π ( ( {d}_{i , n} - {d}_{i , 0} ) + ( {d}_{r , n} - {d}_{r , 0} ) )}{λ}} \cdot {α}_{n} {e}^{j {ϕ}_{n}} \qquad ( 1 )$$

where d_{i,n} is the incidence angle (e.g., the angle/direction from which signals are received), and d_{r,n} is the reflection angle (e.g., the angle/direction that signals are reflected/refracted), and αₙe^{jφ}^{ₙ} is the reflective coefficient of meta-element n.

Comparatively, in the context of the far-field model, the reflection gain (h) of the reconfigurable surface may be defined according to Equation 2 below:

$$h = {Σ}_{n = 0}^{N - 1} {e}^{j \frac{2 π n d}{λ} ( {sin θ}_{i} + {sin θ}_{r} )} \cdot {α}_{n} {e}^{j {ϕ}_{n}} \qquad ( 2 )$$

where θᵢ is the incidence angle, θᵣ is the reflection angle, and αₙe^{jφ}^{ₙ} is the reflective coefficient of meta-element n. In an ideal scenario,

$${α}_{n} ≡ α , {ϕ}_{n} = - \frac{2 π nd}{λ} ( sin {θ}_{i} + sin {θ}_{r} ) .$$

Practically, the term {αₙ, φₙ} may be derived from an enumerated set based on meta-element realization.

As noted previously herein, in some wireless networks, reconfigurable surfaces 305 may be configured to relay communications in accordance with a single reflection configuration at any given time. That is, at any given time, the reconfigurable surface 305 may only be configured to reflect signals received from one of the respective devices shown in FIG. 3 (e.g., reflect signals received from only one of the first network entity 105-a, the second network entity 105-b, the first UE 115-a, or the second UE 115-b) according to a single reflection configuration, and may therefore be unavailable to relay signals from another devices during that same time.

However, when a reconfigurable surface 305 is deployed proximate or adjacent to more than one TRP or network entity 105, multiple TRPs or network entities 105 may have a need to utilize the reconfigurable surface for signal reflection. For example, in some implementations, a single network entity 105 may want to use a reconfigurable surface 305 reflect signals from multiple TRPs of the network entity 105 to one or more UEs 115, as shown in FIG. 3. UEs. Additionally, or alternatively, the reconfigurable surface 305 may be positioned at the border of two serving cells, where the network entities 105 (e.g., network entities 105-a and 105-b) of these two serving cells have a need to use the reconfigurable surface 305 to enhance channel quality for cell-edge UEs 115.

Such scenarios may be addressed using two separate reconfigurable surfaces 305 (each performing one reflection), or by using a single shared reconfigurable surface 305 (where the single RIS performs two simultaneous reflections). Compared with non-shared RIS (one reflection), a shared RIS (two simultaneous reflections) can increase the number of data streams by RIS-based MU-MIMO, thus increase the overall network throughput (sum of two UEs' throughput).

By way of another example, the reconfigurable surface 305 may be implemented within a cell-free network, where two separate network entities 105 (e.g., network entities 105-a, 105-b) want to use the reconfigurable surface 305 to relay signals to the same UE 115 (e.g., first UE 115-a or the second UE 115-b). Once again, compared with non-shared RIS (one reflection), a shared RIS (two simultaneous reflections) can increase the channel gain of the combined links from two network entities 105, thus increase the throughput at the single UE 115.

However, current wireless communications systems do not enable a single reconfigurable surface 305 (e.g., RIS) to simultaneously service or support multiple TRPs. One issue encountered by networks that may attempt to use a single reconfigurable surface 305 to simultaneously reflect signals from multiple TRPs is that, for dynamic scheduling, the real-time RIS reflection configuration used by the reconfigurable surface 305 may come from one or multiple TRPs/network entities 105, which may require a dedicated protocol and signaling design that has not been explored.

Accordingly, aspects of the present disclosure are directed to techniques that enable the reconfigurable surface 305 to relay communications according to multiple different reflection configurations at the same time. In particular, aspects of the present disclosure are directed to design protocols and signaling that enable the reconfigurable surface 305 to be shared across multiple TRPs/network entities 105. Stated differently, the wireless communications system 300 may support signaling that enables the reconfigurable surface 305 to reflect overlapping (e.g., simultaneous) signals received from multiple TRPs according to multiple different reflection configurations.

For example, referring to the wireless communications system 300 illustrated in FIG. 3, the reconfigurable surface 305 may transmit capability information to the first network entity 105-a (e.g., first TRP), the second network entity 105-b (e.g., second TRP), or both, where the capability information indicates a capability of the reconfigurable surface 305 to reflect multiple signals during overlapping (e.g., simultaneous) time intervals in accordance with a different reflection parameter sets. Stated differently, the reconfigurable surface 305 may report a capability of a maximum quantity of simultaneous reflections that it can support at any given time.

In cases where the reconfigurable surface 305 does not include its own power source, the reconfigurable surface 305 may be configured to absorb energy from signals received from the respective network entities 105, and use the absorbed energy to transmit the capability information. In some cases, the capability information may be reported via RRC signaling.

In some cases, the capability information may include information regarding how many sub-surfaces that the reconfigurable surface 305 is able to form. For example, as shown in FIG. 3, the reconfigurable surface 305 may include (or be able to form) a first sub-surface 320-a including a first set of reflective surface elements (e.g., first set of meta-elements), and a second sub-surface 320-b including a second set of reflective surface elements (e.g., second set of meta-elements). In this example, the first sub-surface 320-a may be configured to perform reflections using a first set of reflection parameters (e.g., to reflect signals from the first network entity 105-a to the first UE 115-a), and the second sub-surface 320-b may be configured to perform reflections using a second set of reflection parameters (e.g., to reflect signals from the second network entity 105-b to the second UE 115-b). Stated differently, each sub-surface 320 may independently configure the reflection coefficients of the corresponding meta-elements to realize a reflection from a certain incident direction to a certain reflective direction (e.g., each sub-surface 320 may reflect signals according to a different reflection parameter set).

Higher complexity reconfigurable surfaces 305 may be support larger quantities of sub-surfaces 320 (e.g., may be able to simultaneously support more TRPs). For example, when the reconfigurable surface 305 is used for single reflection (e.g., reflection of signals from a single TRP), all the meta-elements of the reconfigurable surface 305 may support a single set of codewords or reflection coefficients. Comparatively, when the reconfigurable surface 305 is divided into two sub-surfaces 320, the meta-elements in each sub-surface may be configured to support an additional set of codewords/reflection coefficients, which may increase hardware cost and processing complexity.

In such cases, the capability information reported by the reconfigurable surface 305 may indicate a quantity of sub-surfaces 320 that are formable by the reconfigurable surface 305. Such capabilities may be based on a hardware structure of the reconfigurable surface 305 (e.g., the maximum number of sub-surfaces 320 by separating the full reconfigurable surface 305). In some cases, the capability information may indicate candidate split ratios associated with the respective sub-surfaces 320 (e.g., ratios of the respective sub-surface 320 compared to one another and/or compared to the full reconfigurable surface 305). For example, the reconfigurable surface 305 may report, via the capability information, candidate sub-surface 320 split ratios, such as 1:1, 1:2, 1:3, 2:3, etc. In such cases, a split ratio of 1:1 may indicate that the first and second sub-surfaces 320 each span 50% of the reconfigurable surface. Comparatively, a split ratio of 1:2 may indicate that the first sub-surface 320-a spans one third of the surface, where the second sub-surface 320-b spans two thirds of the surface.

In some aspects, and based on the capability information reported by the reconfigurable surface 305, the wireless communications system 300 may support dynamic scheduling at the reconfigurable surface 305. In other words, reflection parameters (e.g., incident/reflection directions, reflection precoders, codewords) used by the reconfigurable surface 305 to reflect signals received from the respective devices may be configured or changed per slot, per TTI, etc. In particular, DCI messages communicated by the respective devices (e.g., network entities 105) may be used to configure and/or adjust reflection parameter sets used by the reconfigurable surface 305 in different slots/TTIs.

According to aspects of the present disclosure, reflection parameter sets used by the reconfigurable surface 305 may be configured via different implementations, including: (1) a single-DCI implementation, and/or (2) via a multi-DCI implementation. Each respective implementation will be described in further detail herein.

In accordance with a single-DCI implementation, the network may configure the reconfigurable surface 305 with multiple reflection parameter sets using a single DCI message. In other words, the first network entity 105-a (e.g., first TRP) may transmit a single DCI message that indicates multiple reflection parameter sets that are to be used by the reconfigurable surface 305 to reflect signals received from different TRPs. Stated differently, if the feature “multi-reflection by single-DCI” is switched on, the network may configure the reconfigurable surface 305 (e.g., via RRC signaling) with a maximum quantity of simultaneous reflections.

For example, in accordance with the single-DCI implementation, the reconfigurable surface 305 may report capability information to support multiple reflection parameter sets (and/or sub-surface 320 split ratios) to the first network entity 105-a. In this example, the first network entity 105-a may configure the reconfigurable surface 305 with a maximum number of simultaneous reflections to be performed by the reconfigurable surface 305, based on the reported capability information. Subsequently, the first network entity 105-a may transmit a single DCI message (e.g., RIS-control DCI) that indicates selected reflection configurations (e.g., selected reflection parameter sets) from a set of candidate reflection configurations (e.g., candidate reflection parameter sets) that may be previously configured via RRC signaling and/or RIS-control multi MAC-CE.

For instance, RRC signaling may be used to indicate multiple candidate reflection parameter sets that may be used by the reconfigurable surface 305, and a single DCI message may indicate that the reconfigurable surface 305 is to use a first reflection parameter set to reflect signals from the first network entity 105-a, and a second reflection parameter set to reflect signals from the second network entity 105-a.

Comparatively, in accordance with a multi-DCI implementation, the network may configure the reconfigurable surface 305 with multiple reflection parameter sets using a multiple DCI messages. In other words, the first network entity 105-a, the second network entity 105-b, or both, may transmit multiple DCI messages, where each DCI message indicates a single reflection configuration (e.g., single reflection parameter set) that is to be used by the reconfigurable surface 305 to reflect signals from the respective TRPs. Stated differently, if the feature “multi-reflection by multi-DCI” is switched on, the network may configure the reconfigurable surface 305 (e.g., via RRC signaling) with a maximum quantity of RIS-control single-reflection DCIs.

For example, in accordance with the multi-DCI implementation, the reconfigurable surface 305 may report capability information to support multiple reflection parameter sets (and/or sub-surface 320 split ratios) to the first network entity 105-a, the second network entity 105-b, or both. In this example, the first network entity 105-a and/or second network entity 105-b may configure the reconfigurable surface 305 with a maximum number of RIS-control single-reflection DCIs that can be received at the reconfigurable surface 305, based on the reported capability information. Subsequently, the first network entity 105-a, the second network entity 105-b, or both, may transmit multiple RIS-control single-reflection DCIs to indicate the selected single-reflection configurations (e.g., indicate single reflection parameter sets) that will be used by the reconfigurable surface 305 to reflect signals (where the selected reflection configurations/reflection parameter sets may be selected from a universe of previously-configured candidate reflection configurations/candidate reflection parameter sets).

In some implementations, the reconfigurable surface 305 may be configured to connect with, or otherwise communicate with, a single TRP/network entity 105 that is designated as an “anchor” TRP/network entity 105. where other TRPs/network entities 105 may be referred to as “non-anchor” TRPs/network entities 105. For example, as shown in FIG. 3, the first network entity 105-a may serve as an anchor TRP for the reconfigurable surface 305, where the second network entity 105-b may be designated as a non-anchor TRP.

In such cases, if the non-anchor network entity 105-b has signals to be communicated to (e.g., reflected by) the reconfigurable surface 305, the non-anchor network entity 105-b may transmit RIS reflection-related information to the anchor network entity 105-a, where the anchor network entity 105-a may relay the information to the reconfigurable surface 305. For example, the non-anchor network entity 105-b may transmit (via a communication link 315, which may be an example, of an Xn interface), a message indicating one or more reflection parameter sets to be used by the reconfigurable surface 305 to reflect signals received from the non-anchor network entity 105-b. In this example, the anchor network entity 105-a may relay the indicated reflection parameter sets to the reconfigurable surface 305.

In cases where the reconfigurable surface 305 is configured via the single-DCI implementation, all the reflection configuration information (e.g., all the reflection parameter sets) may be sent to the reconfigurable surface 305 via a single DCI message transmitted by the anchor network entity 105-a.

Comparatively, in cases where the reconfigurable surface 305 is configured via the multi-DCI implementation, static/semi-static reflection configuration information may be sent by the anchor network entity 105-a, where dynamic reflection configurations/reflection parameter sets may be sent by each of the respective network entities 105-a, 105-b (anchor and non-anchor). For instance, the anchor network entity 105-a may configure the reconfigurable surface 305 with a set of candidate reflection parameter sets that are usable by the reconfigurable surface 305, where each network entity 105 may subsequently transmit DCI messages to the reconfigurable surface 305 indicating which reflection parameter sets from the set of candidates are to be used.

In some aspects, the network (e.g., network entity 105-a, 105-b) may determine the value of “maximum number of simultaneous reflections” or “maximum number of RIS-control single-reflection DCIs” supported by the reconfigurable surface 305 based on the capability information of the reconfigurable surface 305 associated with the maximum number of simultaneous reflections

$$( denoted as {N}_{sub - surface}^{max , cap} ) ,$$

and/or service parameters associated with communications facilitated by the reconfigurable surface (e.g., service requirements, such as quality of service (QoS) parameters). In some cases, the network may specify or regulate the maximum quantity of multiple simultaneous reflections that may be supported by the reconfigurable surface 305

$$( denoted as {N}_{sub - surface}^{max , stan} ) .$$

For example, the quantity of TRPs/network entities 105 that are to use the reconfigurable surface 305 to reflect communications may be defined as N_{node}, and the network (e.g., first network entity 105-a) may configure the maximum quantity of simultaneous reflection or RIS-control single-reflection DCIs

$$( {N}_{reflection}^{max , conf} )$$

that may be supported by the reconfigurable surface 305 according to Equation 3:

$${N}_{reflection}^{max , conf} = min ( {N}_{sub - surface}^{max , cap} , {N}_{reflection}^{max , stan} , {N}_{node} ) \qquad ( 3 )$$

In some aspects, in the context of CSI-RS based beam sweeping, each CSI-RS resource may correspond to one reflection configuration. In other words, each CSI-RS resource may correspond to a reflection parameter set which defines or includes an incident direction/reflection direction pair for reflecting signals by the reconfigurable surface 305. In some aspects, the UEs 115 may be configured to receive reference signals (e.g., CSI-RSs) associated with multiple CSI-RS resources, and may report one or more selected CSI-RSs based on measured signal strengths of the received CSI-RSs. For instance, the network entity 105-a may transmit CSI-RSs to the reconfigurable surface 305, where the reconfigurable surface 305 reflects the CSI-RSs with corresponding reflection parameter sets (e.g., corresponding reflection configurations), and where the UE 115-a performs measurements on the received CSI-RSs and reports which CSI-RS resource (and therefore which reflection parameter set) should be used for communications between the UE 115-a and the network entity 105-a via the reconfigurable surface 305.

In some aspects, for RIS-based data transmission (e.g., communications facilitated by the reconfigurable surface 305), there may be two options for RIS-control DCI designs, based on whether RIS-control MAC CE is used. For example, in accordance with a first option that utilized RIS-control MAC-CE, a network entity 105 may transmit a RIS-control MAC-CE to the reconfigurable surface, where the RIS-control MAC-CE indicates a list of candidate reflection configurations usable by the reconfigurable surface 305 (e.g., the RIS-control MAC-CE indicates a list of candidate reflection parameter sets). Subsequently, DCI messages (either a single DCI or multiple DCIs) may be used to indicate which candidate reflection configuration(s) (e.g., which candidate reflection parameter set(s)) from are to be used by the reconfigurable surface 305.

Comparatively, in accordance with a second option that does not utilize RIS-control MAC-CE, RIS-control DCI messages may be used to directly indicate the index of CSI-RS resources that are previously configured in RRC signaling. In other words, RRC signaling may indicate CSI-RS resources and corresponding candidate reflection configurations (e.g., candidate reflection parameter sets), and DCI messages may be used to indicate which CSI-RS resources (and therefore which corresponding reflection parameter sets) are to be used by the reconfigurable surface 305. In some cases, the first option which utilizes RIS-control MAC-CE may result in lower DCI payloads, but may cause longer latency due to the use of MAC-CEs prior to DCI messages. In some cases, the network may configure or indicate which option is to be used (e.g., whether the reconfigurable surface 305 will be controlled with or without RIS-control MAC-CEs).

Examples may prove to be illustrative. In accordance with a first example that utilizes RIS-control MAC-CEs, the non-anchor network entity 105-b may transmit reflection configurations (e.g., reflection parameter sets, including semi-static and dynamic information) to the anchor network entity 105-a, such as via XnAP messages communicated via the communication link 315. Subsequently, the anchor network entity 105-a may transmit a RIS-control multi-reflection MAC-CE to the reconfigurable surface 305 that indicates a list of candidate multi-reflection configurations. The content of the MAC-CE may be associated with the configured maximum number of simultaneous reflections supported by the reconfigurable surface 305

$$( denoted as {N}_{reflection}^{max , conf} ) ,$$

as described herein.

Continuing with the same example, the MAC-CE may include a list

$$( {N}_{item}^{multi} )$$

of multi-reflection configurations usable by the reconfigurable surface 305, where each multi-reflection configuration contains N single-reflection configurations

$$( with 1 \leq N \leq {N}_{reflection}^{max , conf} ) ,$$

and where

$${N}_{item}^{multi}$$

may be configured by RRC signaling in advance. In other words, each multi-reflection configuration may include multiple candidate reflection parameter sets (e.g., single-reflection configuration) that may be used by the reconfigurable surface 305 to reflect signals. Example contents of a MAC-CE that indicates multiple multi-reflection configurations

$$( assuming {N}_{reflection}^{max , conf} = 2 )$$

is shown in Table 1 below:

TABLE 1
RIS-Control Reflection MAC-CE Contents

| | | |
|---|---|---|
| F | Single-reflection configuration | Multi-reflection |
| | (reflection parameter set) #1 | configuration #1 |
| F | Single-reflection configuration (reflection | |
| | parameter set) #2 | |
| F | Single-reflection configuration (reflection | Multi-reflection |
| | parameter set) #1 | configuration #2 |
| F | Single-reflection configuration | |
| | (reflection parameter set) #3 | |
| | . | |
| | . | |
| | . | |
| F | Single-reflection configuration | Multi-reflection |
| F | (reflection parameter set) #n Single-reflection configuration | $\begin{matrix}configuration \\ {N}_{item}^{multi}\end{matrix}$ |
| | (reflection parameter set) #m | |

As shown in Table 1 above, each multi-reflection configuration may include multiple single-reflection configurations (e.g., each multi-reflection configuration includes multiple reflection parameter sets). For example, in cases where

$${N}_{reflection}^{max , conf} = 2 ,$$

as shown in in Table 1 above, each multi-reflection configuration may include two reflection parameter sets.

As such, in cases where the reconfigurable surface 305 is enabled with the first multi-reflection configuration, the reconfigurable surface 305 may be able to simultaneously reflect signals according to the first reflection parameter set (single-reflection configuration #1) and the second reflection parameter set (single-reflection configuration #2). For instance, the first sub-surface 320-a may reflect signals between the first network entity 105-a and the first UE 115-a using the first reflection parameter set (single-reflection configuration #1) during a time interval, and the second sub-surface 320-b may reflect signals between the second network entity 105-b and the second UE 115-b using the second reflection parameter set (single-reflection configuration #2) during the same time interval.

The individual bit fields denoted by F in Table 1 above (e.g., 1 bit F fields) may be used by the network (e.g., anchor network entity 105-a) to indicate whether each respective single-reflection configuration is valid or invalid (e.g., to indicate whether each respective reflection parameter set is invalid or not). If F=1, then the respective reflection parameter set may be valid, where the respective reflection parameter set may be invalid if F=0. For a multi-reflection configuration, if

$$N < {N}_{reflection}^{max , conf} ,$$

then the last

$${N}_{reflection}^{max , conf} - N$$

single-reflection configurations are invalid. In this regard, the MAC-CE illustrated in Table 1 may be used to indicate which candidate multi-reflection configurations may be used by the reconfigurable surface 305 (by indicating valid/invalid for the respective rows).

As noted previously herein, each reflection parameter set (e.g., each single-reflection configuration) may be associated with a CSI-RS resource ID, a RIS reflection codeword index, a pair of an incident/reflective directions, or any combination thereof. In some cases, the list of multi-reflection configurations and/or single-reflection configurations may be determined by the network based on reports received from UEs 115 which indicate selected CSI-RS resources (and/or based on the relative position/location of the respective UEs 115).

Subsequently, the first network entity 105-a and/or the second network entity 105-b may transmit one or more DCI messages to the reconfigurable surface 305 to indicate the index(es) of the multi-reflection configurations that are to be used by the reconfigurable surface 305 from the list of candidate multi-reflection configurations indicated by the RIS-control multi-reflection MAC-CE, as shown in Table 1 above. In other words, DCI messages may be used to indicated indices that are associated with reflection parameter sets to be used by the reconfigurable surface 305. In some cases, DCI messages may further indicate time/frequency domain resources (e.g., sets of symbols/slots) associated with communications performed using the respective reflection parameter sets, sub-surface 320 size configurations associated with the respective reflection parameter sets, and the like.

In cases where the reconfigurable surface 305 is configured without RIS-control MAC-CE, parameters that have been described herein as being configured via the MAC-CEs may instead be configured via a DCI message(s).

In cases where the reconfigurable surface 305 is controlled in the single-DCI implementation (e.g., the reconfigurable surface 305 receives a single DCI message that indicates multiple reflection parameter sets), the reconfigurable surface 305 may be configured with a single CORESET, where the reconfigurable surface 305 is configured to monitor one or more search spaces in the configured CORESET for signaling (e.g., MAC-CE, DCI messages) from the respective network entities 105. Moreover, in some cases where a network includes multiple reconfigurable surfaces 305, each respective reconfigurable surface 305 may be configured with a separate search space, which may be within the same or different CORESETs.

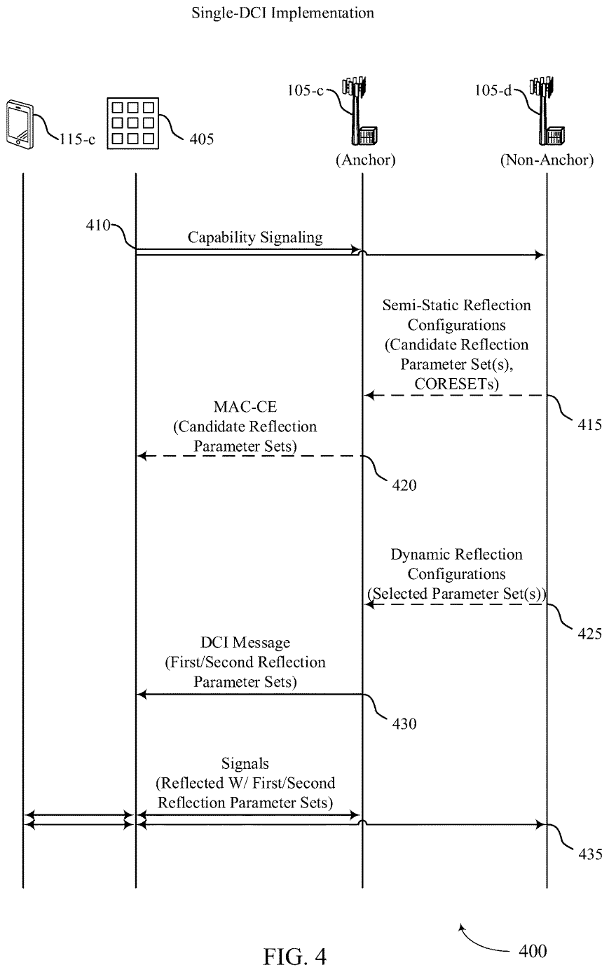

An example of the single-DCI implementation (e.g., implementation that uses a single DCI message to configure reflection parameter sets at the reconfigurable surface 305) will be further shown and described with reference to FIG. 4.

Comparatively, in cases where the reconfigurable surface 305 is controlled in the multi-DCI implementation (e.g., the reconfigurable surface 305 receives multiple DCI message that each indicate a single reflection parameter set), the reconfigurable surface 305 may be configured with multiple CORESET, such as a different CORESET for the respective TRPs/network entities 105. For instance, the reconfigurable surface 305 may receive signaling indicating a first CORESET associated with the first network entity 105-a, and a second CORESET associated with the second network entity 105-b. In this example, the reconfigurable surface may be configured to monitor the respective CORESETS to receive DCI messages indicating reflection parameter sets (e.g., reflection configurations) from the respective network entities 105.

In cases where the reconfigurable surface 305 is to serve separate gNBs, the anchor gNB (e.g., first network entity 105-a) may indicate an RIS radio network temporary identifier (RNTI) value to non-anchor gNB (e.g., second network entity 105-b), such as via an XnAP message communicated via the communication link 315. In such cases, the non-anchor gNB (e.g., second network entity 105-b) may indicate (e.g., via an XnAP message) the CORESET and search space that will be used for communications between the non-anchor gNB and the reconfigurable surface 305 to the anchor gNB (where the anchor gNB may be configured to relay such information to the reconfigurable surface 305 as static information).

As described previously herein with respect to the single-DCI implementation (e.g., implementation that uses a single DCI message to configure reflection parameter sets at the reconfigurable surface 305), the multi-DCI implementation (e.g., implementation that uses multiple DCI messages to configure reflection parameter sets at the reconfigurable surface 305) may include two different options which do and do not utilize RIS-control MAC-CE, respectively.

For example, in the context of the multi-DCI implementation with RIS-control MAC-CE, the anchor gNB (e.g., first network entity 105-a) may transmit a RIS-control single-reflection MAC-CE to the reconfigurable surface 305 to indicate a list of candidate single-reflection configurations. The MAC-CE may include a list of single-reflection configurations

$${N}_{item}^{single} ,$$

where

$${N}_{item}^{single}$$

may be configured by RRC signaling in advance. In other words, the MAC-CE may indicate multiple single-reflection configurations (e.g., reflection parameter sets) that may be used by the reconfigurable surface 305 to reflect signals. Example contents of a RIS-control MAC-CE that indicates different reflection configurations is shown in Table 2 below:

TABLE 2
RIS-Control Reflection MAC-CE Contents

Single-reflection configuration (reflection parameter set) #1
Single-reflection configuration (reflection parameter set) #2
.
.
.
$Single - reflection configuration ( reflection parameter set ) {N}_{item}^{multi}$

As noted previously herein, each reflection configuration (e.g., each reflection parameter set) may be associated with a CSI-RS resource ID, a RIS reflection codeword index, and/or a pair of an incident/reflective directions. The list of candidate reflection parameter sets indicated via a MAC-CE (as shown in Table 2) may be determined by the network based on CSI-RS resources selected/reported by the respective UEs 115, based on the position/location of the respective UEs 115, or both.

In cases where the reconfigurable surface 305 is to serve multiple gNBs, the non-anchor gNB (e.g., second network entity 105-b) may indicate, to the anchor gNB, a list of candidate reflection parameter sets that may be used by the reconfigurable surface 305 for reflecting signals from the non-anchor gNB, such as via an XnAP message communicated via the communication link 315. In such cases, the anchor gNB (e.g., first network entity 105-a) may be configured to generate a unified list of all candidate reflection parameter sets (e.g., list of all candidate reflection configurations) that may be used by the reconfigurable surface 305 for reflecting signals from the served TRPs/network entities 105, and may transmit the MAC-CE indicating the list of all candidate reflection parameter sets to the reconfigurable surface 305 (as shown in Table 2 above). The list of candidate reflection parameter sets may be considered to be semi-static information communicated to the reconfigurable surface 305.

Continuing with the same example, and as noted previously herein, after being configured with candidate reflection parameter sets via RIS-control MAC-CE, the first network entity 105-a, the second network entity 105-b, or both, may transmit DCI messages (dynamic information) to the reconfigurable surface 305, where each DCI message indicates an index corresponding to a single reflection configuration (e.g., single reflection parameter set) from the list of candidate reflection configurations indicated via MAC-CE. In other words, the network entities 105 may transmit DCI messages, where each DCI message indicates an entry corresponding to a reflection parameter set from Table 2. In this example, the DCI messages may additionally indicate a set of time/frequency resources (e.g., a set of symbols/slots) associated with each respective reflection parameter sets, a sub-surface 320 size configuration associated with the respective reflection parameter set, or both.

In cases where the reconfigurable surface 305 is configured via the multi-DCI implementation without RIS-control MAC-CE, parameters that have been described herein as being configured via the MAC-CEs may instead be configured via DCI messages received from the respective network entities 105.

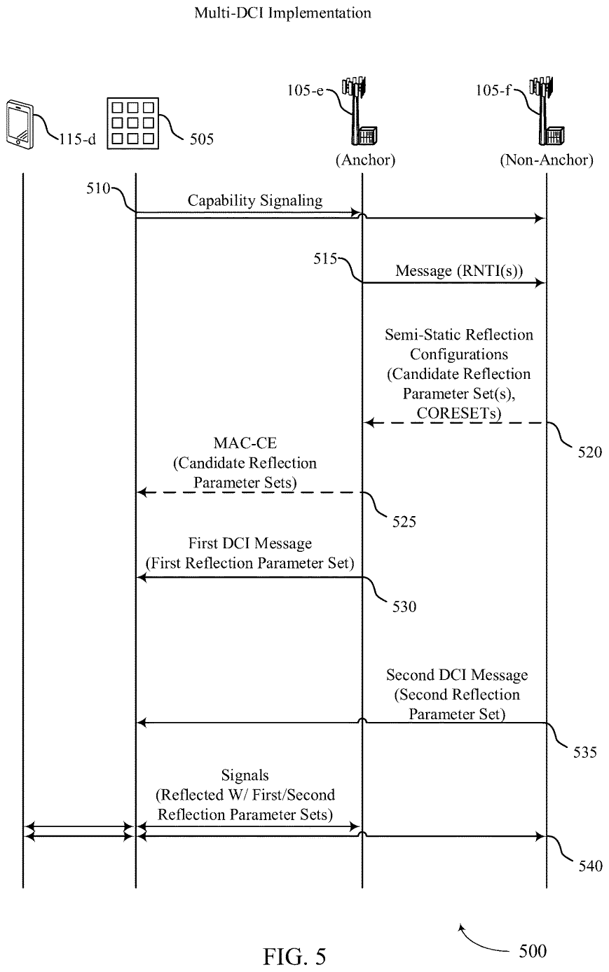

An example of the multi-DCI implementation (e.g., implementation that uses multiple DCI messages to configure reflection parameter sets at the reconfigurable surface 305) will be further shown and described with reference to FIG. 5.

In some aspects, the network may indicate (or relevant standards may define) whether single-DCI implementation or the multi-DCI implementation will be used to configure reconfigurable surface 305 with reflection parameter sets, and/or whether the different types of RIS-control DCI messages may be used at the same time. In other words, the network may indicate (and/or relevant standards may define) whether the reconfigurable surface 305 is to receive a single DCI message that indicates multiple reflection parameter sets that are to be used to reflect signals received from multiple TRPs in the same time interval (single-DCI implementation), or whether the reconfigurable surface 305 is to receive multiple DCI messages that each indicate a single reflection parameter set that is to be used to reflect signals received from a respective TRP in the time interval (multi-DCI implementation).

In cases where both the single-DCI implementation and the multi-DCI implementation is enabled for a single symbol/slot/TTI, the network may indicate (or relevant standards may define) what type of DCI has a higher priority (e.g., whether the reconfigurable surface is to prioritize DCI messages that indicate multiple reflection parameter sets over DCI messages that indicate a single reflection parameter set, or vice versa).

The single-DCI implementation and the multi-DCI implementation may each be associated with respective advantages and disadvantages. For example, because the single-DCI implementation utilizes a single DCI message to configure the reconfigurable with multiple reflection parameter sets/reflection configurations, the single-DCI implementation may result in less radio resource consumption. Moreover, the single-DCI implementation may not require inter-gNB CORESET and/or inter-gNB RNTI static indications, thereby resulting in less signaling overhead. However, the single-DCI implementation may result in longer dynamic latency for configuring the reconfigurable surface 305, and may require more inter-gNB dynamic signaling.

Comparatively, the multi-DCI implementation may reduce dynamic latency for configuring the reconfigurable surface 305, as the multi-DCI implementation may require less (or no) inter-gNB dynamic information signaling. However, because the multi-DCI implementation utilizes multiple DCI messages to configure the reconfigurable with reflection parameter sets/reflection configurations, the multi-DCI implementation may result in more radio resource consumption (e.g., increased signaling overhead).

In cases where the reconfigurable surface 305 may be configured via both the single-DCI implementation and the multi-DCI implementation, the two types of RIS-control DCI messages may be associated/configured with corresponding RNTI values. For example, the reconfigurable surface 305 may receive control signaling (e.g., RRC signaling) that indicates a first RNTI value associated with DCI messages used in accordance with the single-DCI implementation, and a second RNTI value associated with DCI messages used in accordance with the multi-DCI implementation. In other words, DCI messages that indicate multiple reflection parameter sets (for the single-DCI implementation), and DCI messages that indicate a single reflection parameter set (for the multi-DCI implementation) may be associated with different RNTI values.

In additional or alternative implementations, DCI messages for both the single-DCI implementation and the multi-DCI implementation may be associated with a common RNTI value. For example, the reconfigurable surface 305 may receive control signaling (e.g., RRC signaling) that indicates a single RNTI value associated with DCI messages used in accordance with the single-DCI implementation and the multi-DCI implementation. In such cases, a bit field in DCI messages communicated to the reconfigurable surface 305 may be used to indicate whether the respective DCI message follows the format of for the single-DCI implementation or the multi-DCI implementation. In other words, DCI messages may include a bit field which indicates whether the respective DCI messages configures the reconfigurable surface 305 with multiple reflection parameter sets (for the single-DCI implementation) or with a single reflection parameter set (for the multi-DCI implementation).

Under either implementation (e.g., either the single-DCI implementation, or the multi-DCI implementation), after receiving one or more RIS-control DCI message(s) indicating one or more reflection parameter sets, the reconfigurable surface 305 may be configured to utilize the indicated reflection parameter sets (e.g., use the indicated reflection configurations) to reflect/refract signals received from the respective network entities 105. In particular, the reconfigurable surface 305 may utilize the indicated reflection parameter sets to reflect signals received from the first network entity 105-a and the second network entity 105-b during the same time interval (e.g., use the multiple reflection parameter sets to simultaneously reflect different signals).

For example, the reconfigurable surface 305 may be configured to split the surface to generate multiple sub-surfaces 320, and may apply reflection coefficients associated with the meta-elements of each sub-surface 320 to generate the indicated reflection configuration/reflection parameter set (or one sub-surface 320 for one reflection). Further, in cases where the received DCI message(s) indicate sub-surface 320 size configurations associated with the respective reflection parameter sets, the reconfigurable surface 305 may be configured to utilize the indicated sub-surface 320 size configurations.

Techniques described herein may enable the reconfigurable surface 305 to simultaneously relay signals received from multiple TRPs (e.g., multiple network entities 105) in accordance with different reflection configurations/reflection parameter sets. Accordingly, aspects of the present disclosure may be used to increase coverage and throughput associated with TRPs within the wireless communications system 300, thereby leading to more efficient and reliable wireless communications. Moreover, techniques described herein may enable multiple TRPs to utilize a single reconfigurable surface 305 at the same time, thereby leading to more efficient and widespread use of reconfigurable surfaces 305 to further circumvent obstructions and improve data throughput.

FIG. 4 illustrates an example of a process flow 400 that supports techniques for sharing RISs among multiple TRPs in accordance with one or more aspects of the present disclosure. Aspects of the process flow 400 may implement, or be implemented by, aspects of the wireless communications system 100, the network architecture 200, the wireless communications system 300, or any combination thereof. In particular, the process flow 400 illustrates example signaling between devices used to configure a reconfigurable surface 405 using the single-DCI implementation, as described previously herein.

The process flow 400 includes a UE 115-c, a reconfigurable surface 405, a first network entity 105-c (e.g., TRP1, anchor TRP), and a second network entity 105-d (e.g., TRP2, non-anchor TRP), which may be examples of UEs 115, reconfigurable surfaces, network entities 105, and other wireless devices as described herein. For example, the UE 115-c and the reconfigurable surface 405 illustrated in FIG. 4 may be examples of the UE 115-a and the reconfigurable surface 305, respectively, as illustrated in FIG. 3. In this regard, the reconfigurable surface 405 may include comprises a set of multiple of reflective surface elements that are configured to reflect signals according to reflection parameter sets (e.g., sets of precoders, reflection coefficients, etc.).

Similarly, the first network entity 105-c and the second network entity 105-d illustrated in FIG. 4 may be examples of the first network entity 105-a and the second network entity 105-b, respectively, as illustrated in FIG. 3. In this regard, the first network entity 105-c may serve as an anchor TRP/gNB for the reconfigurable surface 405, while the second network entity 105-b may be an example of a non-anchor TRP/gNB, as described herein.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 410, the reconfigurable surface 405 may transmit capability information to the first network entity 105-c, the second network entity 105-b, or both. The capability information may indicate a capability of the reconfigurable surface 405 to reflect multiple signals during overlapping time intervals in accordance with multiple reflection parameter sets (e.g., multiple reflection configurations). In other words, the capability signaling may indicate a capability of the reconfigurable surface 405 to simultaneously support or service multiple TRPs, such as the network entities 105-c, 105-d.

The capability signaling may indicate additional information associated with the capability of the reconfigurable surface 405 to simultaneously support multiple TRPs. For example, in some cases, the capability signaling may indicate a maximum quantity of reflection parameter sets (e.g., maximum quantity of reflection configurations) supported by the reconfigurable surface 405 during overlapping time intervals. In other words, the capability signaling may indicate that the reconfigurable surface may simultaneously support up to two, three, four, etc. reflection parameter sets at any one time.

In additional or alternative implementations, the capability signaling may indicate a quantity of sub-surfaces associated with the reconfigurable surface 405, where each sub-surface is configured to support a respective reflection parameter set during overlapping time intervals. The capability information may indicate sub-surface size ratios and other information associated with the capability of the reconfigurable surface 405 to split up into multiple sub-surfaces.

At 415, the second network entity 105-d (e.g., non-anchor TRP/gNB) may transmit a message to the first network entity 105-c (e.g., anchor TRP/gNB), where the message indicates semi-static information associated with the reconfigurable surface 405. For example, the message at 415 may include candidate reflection parameter sets (e.g., candidate reflection configurations) usable by the reconfigurable surface 405 for reflecting signals to/from the second network entity 105-d, one or more CORESETs associated with communications between the reconfigurable surface 405 and the second network entity 105-b, or both. In some cases, the second network entity 105-d may transmit the message at 415 based on receiving the capability signaling at 410.

At 420, the first network entity 105-c may transmit a MAC-CE message to the reconfigurable surface 405. In some aspects, the MAC-CE message may indicate a list of candidate reflection parameter sets (e.g., list of candidate reflection configurations) usable by the reconfigurable surface 405 for reflecting signals to/from the first network entity 105-c and/or the second network entity 105-d. For example, the MAC-CE message may indicate candidate reflection parameter sets as shown and described in Table 1 above.

In additional or alternative implementations, the MAC-CE (and/or other control signaling) may indicate other parameters associated with communications with the respective network entities 105, such as applicable CORESET(s), RNTI(s), and the like. In some cases, the first network entity 105-c may transmit the MAC-CE message at 420 based on receiving the capability signaling at 410, receiving the message at 415, or both.

At 425, the second network entity 105-d may transmit an additional message to the first network entity 105-c (e.g., anchor TRP/gNB), where the additional message indicates dynamic information associated with the reconfigurable surface 405. For example, the additional message at 425 may indicate which reflection parameter sets (e.g., which reflection configurations) from the list of candidate reflection parameter sets which were indicated at 415 and/or 420 are to be used by the reconfigurable surface 405 for reflecting signals to/from the second network entity 105-d. In some cases, the second network entity 105-d may transmit the additional message at 425 based on receiving the capability signaling at 410, transmitting the message at 415, or both.

At 430, the reconfigurable surface 405 may receive, from the first network entity 105-c, a DCI message that indicates multiple reflection parameter sets that are to be used by the reconfigurable surface 405 for reflecting signals received from the respective network entities 105 in overlapping time intervals. In other words, the DCI message may indicate which candidate reflection parameter sets from the list of candidate reflection parameter sets (as shown in Table 1) are to be used by the reconfigurable surface 405.

For example, the DCI message may indicate a first reflection parameter set usable for reflecting signals to/from the first network entity 105-c, and a second reflection parameter set usable for reflecting signals to/from the second network entity 105-d. As noted previously herein, each reflection parameter set (e.g., each reflection configuration) may be associated with a corresponding CSI-RS resource ID, RIS reflection codeword index, pair of incident/reflection directions, or any combination thereof.

In some cases, the reconfigurable surface 405 may receive the DCI message at 430 based on transmitting the capability signaling at 410, receiving the MAC-CE message at 420, or both. For example, the reconfigurable surface 405 may monitor one or more CORESETs (which may be configured via the MAC-CE message at 420 and/or other control signaling, such as RRC signaling), and may receive the DCI message based on the monitoring. In cases where the reconfigurable surface 405 does not receive the MAC-CE message at 420, information described herein as being indicated via the MAC-CE message may alternatively be indicated via the DCI message at 430.

The DCI message may indicate other information for configuring the reconfigurable surface, such as sets of resources (e.g., time resources) associated with the configured reflection parameter sets, sub-surface size configurations associated with the reflection parameter sets, and the like.

At 435, the reconfigurable surface 405 may reflect signals between the UE 115-c (and/or other wireless devices) and the first network entity 105-c, and between the UE 115-c (and/or other wireless devices) and the second network entity 105-d. In particular, the reconfigurable surface 405 may reflect signals to and from the network entities 105-c, 105-d in overlapping (e.g., simultaneous) time intervals.

For example, the reconfigurable surface may reflect signals to/from the first network entity 105-c in accordance with the first reflection parameter set during a time interval, and may reflect signals to/from the second network entity 105-d in accordance with the second reflection parameter set during the same time interval or an overlapping time interval. In cases where the DCI message indicates sets of resources and/or sub-surface size configurations to be used by the reconfigurable surface 405, the reconfigurable surface 405 may perform the reflections at 435 within the indicated resources, and/or in accordance with the indicated sub-surface size configurations.

FIG. 5 illustrates an example of a process flow500 that supports techniques for sharing RISs among multiple TRPs in accordance with one or more aspects of the present disclosure. Aspects of the process flow 500 may implement, or be implemented by, aspects of the wireless communications system 100, the network architecture 200, the wireless communications system 300, the process flow 400, or any combination thereof. In particular, the process flow 500 illustrates example signaling between devices used to configure a reconfigurable surface 505 using the multi-DCI implementation, as described previously herein.

The process flow 500 includes a UE 115-d, a reconfigurable surface 505, a first network entity 105-e (e.g., TRP1, anchor TRP), and a second network entity 105-f (e.g., TRP2, non-anchor TRP), which may be examples of UEs 115, reconfigurable surfaces, network entities 105, and other wireless devices as described herein. For example, the UE 115-d and the reconfigurable surface 505 illustrated in FIG. 4 may be examples of the UE 115-a and the reconfigurable surface 305, respectively, as illustrated in FIG. 3, and/or the UE 115-c and the reconfigurable surface 405, respectively, as illustrated in FIG. 4. In this regard, the reconfigurable surface 505 may include comprises a set of multiple of reflective surface elements that are configured to reflect signals according to reflection parameter sets (e.g., sets of precoders, reflection coefficients, etc.).

Similarly, the first network entity 105-e and the second network entity 105-f illustrated in FIG. 4 may be examples of the first network entity 105-a and the second network entity 105-b, respectively, as illustrated in FIG. 3, and/or the first network entity 105-c and the second network entity 105-d, respectively, as illustrated in FIG. 4. In this regard, the first network entity 105-e may serve as an anchor TRP/gNB for the reconfigurable surface 505, while the second network entity 105-b may be an example of a non-anchor TRP/gNB, as described herein.

In some examples, the operations illustrated in process flow 500 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 510, the reconfigurable surface 505 may transmit capability information to the first network entity 105-e, the second network entity 105-b, or both. The capability information may indicate a capability of the reconfigurable surface 505 to reflect multiple signals during overlapping time intervals in accordance with multiple reflection parameter sets (e.g., multiple reflection configurations). In other words, the capability signaling may indicate a capability of the reconfigurable surface 505 to simultaneously support or service multiple TRPs, such as the network entities 105-e, 105-f.

The capability signaling may indicate additional information associated with the capability of the reconfigurable surface 505 to simultaneously support multiple TRPs. For example, in some cases, the capability signaling may indicate a maximum quantity of reflection parameter sets (e.g., maximum quantity of reflection configurations) supported by the reconfigurable surface 505 during overlapping time intervals. In other words, the capability signaling may indicate that the reconfigurable surface may simultaneously support up to two, three, four, etc. reflection parameter sets at any one time.

In additional or alternative implementations, the capability signaling may indicate a quantity of sub-surfaces associated with the reconfigurable surface 505, where each sub-surface is configured to support a respective reflection parameter set during overlapping time intervals. The capability information may indicate sub-surface size ratios and other information associated with the capability of the reconfigurable surface 505 to split up into multiple sub-surfaces.

At 515, the first network entity 105-e (e.g., anchor TRP/gNB) may transmit a message to the second network entity 105-f (e.g., non-anchor TRP/gNB), where the message indicates one or more RNTIs associated with communications between the reconfigurable surface 505 and the respective network entities 105. The first network entity 105-e may transmit the message at 515 based on receiving the capability signaling at 510.

At 520, the second network entity 105-f (e.g., non-anchor TRP/gNB) may transmit a message to the first network entity 105-e (e.g., anchor TRP/gNB), where the message indicates semi-static information associated with the reconfigurable surface 505. For example, the message at 520 may include candidate reflection parameter sets (e.g., candidate reflection configurations) usable by the reconfigurable surface 505 for reflecting signals to/from the second network entity 105-f, one or more CORESETs associated with communications between the reconfigurable surface 505 and the second network entity 105-b, or both. In some cases, the second network entity 105-f may transmit the message at 520 based on receiving the capability signaling at 510, receiving the message at 515, or both.

At 525, the first network entity 105-e may transmit a MAC-CE message to the reconfigurable surface 505. In some aspects, the MAC-CE message may indicate a list of candidate reflection parameter sets (e.g., list of candidate reflection configurations) usable by the reconfigurable surface 505 for reflecting signals to/from the first network entity 105-e and/or the second network entity 105-f. For example, the MAC-CE message may indicate candidate reflection parameter sets as shown and described in Table 2 above.

In additional or alternative implementations, the MAC-CE (and/or other control signaling) may indicate other parameters associated with communications with the respective network entities 105, such as applicable CORESET(s), RNTI(s), and the like. In some cases, the first network entity 105-e may transmit the MAC-CE message at 520 based on receiving the capability signaling at 510, transmitting the message at 515, receiving the message at 520, or both.

At 530, the reconfigurable surface 505 may receive, from the first network entity 105-e, a first DCI message that indicates a first reflection parameter set that is to be used by the reconfigurable surface 505 for reflecting signals received from the first network entity 105-e. In other words, the first DCI message may indicate which candidate reflection parameter set from the list of candidate reflection parameter set (as shown in Table 2) is to be used by the reconfigurable surface 505 for reflecting signals to/from the first network entity 105-e.

At 535, the reconfigurable surface 505 may receive, from the second network entity 105-f, a second DCI message that indicates a second reflection parameter set that is to be used by the reconfigurable surface 505 for reflecting signals received from the second network entity 105-f. In other words, the second DCI message may indicate which candidate reflection parameter set from the list of candidate reflection parameter set (as shown in Table 2) is to be used by the reconfigurable surface 505 for reflecting signals to/from the second network entity 105-f.

In this regard, as compared to the single-DCI implementation illustrated in FIG. 4 in which the reconfigurable surface 405 receives a single DCI message that indicates multiple reflection parameter sets, the reconfigurable surface 505 illustrated in FIG. 5 may receive multiple DCI messages that each indicate a single reflection parameter set in accordance with the multi-DCI implementation.

As noted previously herein, each reflection parameter set (e.g., each reflection configuration) may be associated with a corresponding CSI-RS resource ID, RIS reflection codeword index, pair of incident/reflection directions, or any combination thereof.

In some cases, the reconfigurable surface 505 may receive the DCI message(s) at 530 and/or 535 based on transmitting the capability signaling at 510, receiving the MAC-CE message at 525, or both. For example, the reconfigurable surface 505 may monitor one or more CORESETs (which may be configured via the MAC-CE message at 525 and/or other control signaling, such as RRC signaling), and may receive the DCI messages based on the monitoring. In cases where the reconfigurable surface 505 does not receive the MAC-CE message at 525, information described herein as being indicated via the MAC-CE message may alternatively be indicated via the DCI message(s) at 530 and/or 535.

The DCI messages at 530 and/or 535 may indicate other information for configuring the reconfigurable surface, such as sets of resources (e.g., time resources) associated with the configured reflection parameter sets, sub-surface size configurations associated with the reflection parameter sets, and the like.

At 540, the reconfigurable surface 505 may reflect signals between the UE 115-d (and/or other wireless devices) and the first network entity 105-e, and between the UE 115-d (and/or other wireless devices) and the second network entity 105-f. In particular, the reconfigurable surface 505 may reflect signals to and from the network entities 105-e, 105-f in overlapping (e.g., simultaneous) time intervals.

For example, the reconfigurable surface may reflect signals to/from the first network entity 105-e in accordance with the first reflection parameter set during a time interval, and may reflect signals to/from the second network entity 105-f in accordance with the second reflection parameter set during the same time interval or an overlapping time interval. In cases where the DCI messages indicate sets of resources and/or sub-surface size configurations to be used by the reconfigurable surface 505, the reconfigurable surface 505 may perform the reflections at 540 within the indicated resources, and/or in accordance with the indicated sub-surface size configurations.

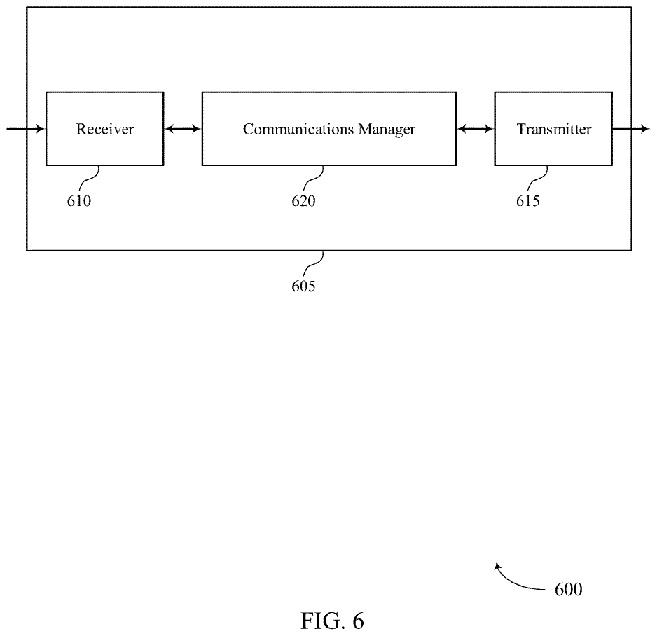

FIG. 6 illustrates a block diagram 600 of a device 605 that supports techniques for sharing RISs among multiple TRPs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for sharing RISs among multiple TRPs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for sharing RISs among multiple TRPs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for sharing RISs among multiple TRPs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 may be configured as or otherwise support a means for transmitting capability information indicating a capability of the reconfigurable surface to reflect a set of multiple signals during overlapping time intervals in accordance with a corresponding set of multiple different reflection parameter sets. The communications manager 620 may be configured as or otherwise support a means for receiving, based on the capability information, one or more control messages indicating at least a first reflection parameter set and a second reflection parameter set for reflecting signals received from a first TRP and a second TRP, respectively, during overlapping time intervals. The communications manager 620 may be configured as or otherwise support a means for reflecting a first signal received from the first TRP within a first time interval using the first reflection parameter set. The communications manager 620 may be configured as or otherwise support a means for reflecting a second signal received from the second TRP within a second time interval that at least partially overlaps with the first time interval using the second reflection parameter set.

By including or configuring the communications manager 620 in accordance with examples as described herein, the device 605 (e.g., a processor controlling or otherwise coupled with the receiver 610, the transmitter 615, the communications manager 620, or a combination thereof) may support techniques that enable RISs to simultaneously relay signals received from multiple TRPs in accordance with different reflection configurations. Accordingly, aspects of the present disclosure may be used to increase coverage and throughput associated with TRPs within a network, thereby leading to more efficient and reliable wireless communications. Moreover, techniques described herein may enable multiple TRPs to utilize a single RIS at the same time, thereby leading to more efficient and widespread use of RIS to further circumvent obstructions and improve data throughput.

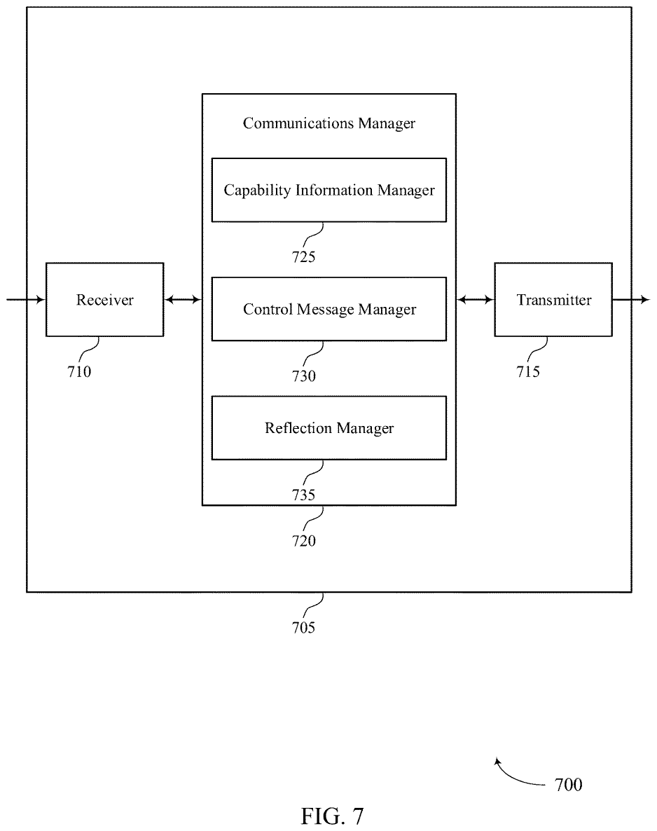

FIG. 7 illustrates a block diagram 700 of a device 705 that supports techniques for sharing RISs among multiple TRPs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for sharing RISs among multiple TRPs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for sharing RISs among multiple TRPs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for sharing RISs among multiple TRPs as described herein. For example, the communications manager 720 may include a capability information manager 725, a control message manager 730, a reflection manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The capability information manager 725 may be configured as or otherwise support a means for transmitting capability information indicating a capability of the reconfigurable surface to reflect a set of multiple signals during overlapping time intervals in accordance with a corresponding set of multiple different reflection parameter sets. The control message manager 730 may be configured as or otherwise support a means for receiving, based on the capability information, one or more control messages indicating at least a first reflection parameter set and a second reflection parameter set for reflecting signals received from a first TRP and a second TRP, respectively, during overlapping time intervals. The reflection manager 735 may be configured as or otherwise support a means for reflecting a first signal received from the first TRP within a first time interval using the first reflection parameter set. The reflection manager 735 may be configured as or otherwise support a means for reflecting a second signal received from the second TRP within a second time interval that at least partially overlaps with the first time interval using the second reflection parameter set.

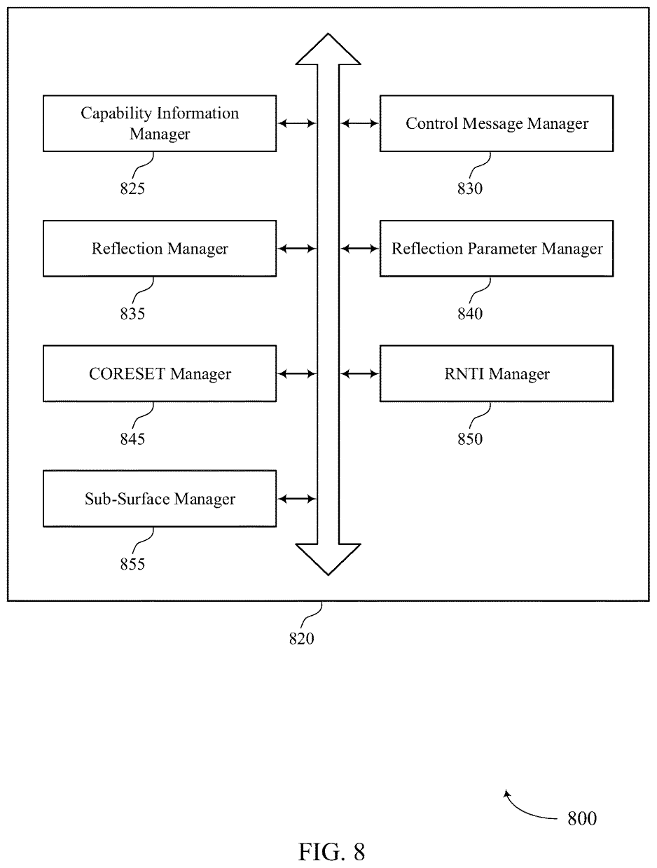

FIG. 8 illustrates a block diagram 800 of a communications manager 820 that supports techniques for sharing RISs among multiple TRPs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for sharing RISs among multiple TRPs as described herein. For example, the communications manager 820 may include a capability information manager 825, a control message manager 830, a reflection manager 835, a reflection parameter manager 840, a CORESET manager 845, an RNTI manager 850, a sub-surface manager 855, or any combination thereof. Each of these components may communicate, directly or indirectly, with one another (e.g., via one or more buses).

The capability information manager 825 may be configured as or otherwise support a means for transmitting capability information indicating a capability of the reconfigurable surface to reflect a set of multiple signals during overlapping time intervals in accordance with a corresponding set of multiple different reflection parameter sets. The control message manager 830 may be configured as or otherwise support a means for receiving, based on the capability information, one or more control messages indicating at least a first reflection parameter set and a second reflection parameter set for reflecting signals received from a first TRP and a second TRP, respectively, during overlapping time intervals. The reflection manager 835 may be configured as or otherwise support a means for reflecting a first signal received from the first TRP within a first time interval using the first reflection parameter set. In some examples, the reflection manager 835 may be configured as or otherwise support a means for reflecting a second signal received from the second TRP within a second time interval that at least partially overlaps with the first time interval using the second reflection parameter set.

In some examples, to support receiving the one or more control messages, the reflection parameter manager 840 may be configured as or otherwise support a means for receiving a single DCI message from the first TRP or the second TRP, where the single DCI message indicates the at least the first reflection parameter set and the second reflection parameter set, and where reflecting the first signal and the second signal is based on receiving the single DCI message.

In some examples, to support receiving the one or more control messages, the reflection parameter manager 840 may be configured as or otherwise support a means for receiving, from the first TRP, a first DCI message indicating the first reflection parameter set, where reflecting the first signal is based on receiving the first DCI message. In some examples, to support receiving the one or more control messages, the reflection parameter manager 840 may be configured as or otherwise support a means for receiving, from the second TRP, a second DCI message indicating the second reflection parameter set where reflecting the second signal is based on receiving the second DCI message.

In some examples, the reflection parameter manager 840 may be configured as or otherwise support a means for receiving control signaling indicating a maximum quantity of reflection parameter sets configurable at the reconfigurable surface for a single time interval, where the control signaling is received based on the capability information.

In some examples, the control message manager 830 may be configured as or otherwise support a means for receiving control signaling indicating a set of multiple reflection parameter set identifiers associated with a set of multiple candidate reflection parameter sets, where the one or more control messages indicate a subset of the set of multiple reflection parameter set identifiers corresponding to at least the first reflection parameter set and the second reflection parameter set included within the set of multiple candidate reflection parameter sets.

In some examples, the control message manager 830 may be configured as or otherwise support a means for receiving, via the one or more control messages, an indication of a first set of resources associated with the first reflection parameter set and an indication of a second set of resources associated with the second reflection parameter set, where the first time interval and the second time interval are associated with the first set of resources and the second set of resources, respectively.

In some examples, the capability information manager 825 may be configured as or otherwise support a means for transmitting, via the capability information, an indication of a maximum quantity of reflection parameter sets supported by the reconfigurable surface during overlapping time intervals, where receiving the one or more control messages is based on the indication of the maximum quantity of reflection parameter sets.

In some examples, the capability information manager 825 may be configured as or otherwise support a means for transmitting, via the capability information, an indication of a set of multiple sub-surfaces associated with the reconfigurable surface, where each sub-surface of the set of multiple sub-surfaces is configured to support a respective reflection parameter set during overlapping time intervals, where receiving the one or more control messages is based on the indication of the set of multiple sub-surfaces.

In some examples, the sub-surface manager 855 may be configured as or otherwise support a means for receiving, via the one or more control messages, an indication of a first sub-surface and a second sub-surface of the set of multiple sub-surfaces associated with the first reflection parameter set and the second reflection parameter set, respectively, where the first signal is reflected using the first sub-surface, and where the second signal is reflected using the second sub-surface.

In some examples, the reflection parameter manager 840 may be configured as or otherwise support a means for receiving, via control signaling, the one or more control messages, or both, a first set of one or more parameters associated with the first reflection parameter set and a second set of one or more parameters associated with the second reflection parameter set, where the first signal and the second signal are reflected based on the first set of one or more parameters and the second set of one or more parameters, respectively, where the first set of one or more parameters, the second set of one or more parameters, or both, include a CRI, a reflection codeword index, a reflection coefficient, a pair of incident and reflective direction angles, or any combination thereof.

In some examples, the CORESET manager 845 may be configured as or otherwise support a means for receiving control signaling indicating one or more CORESETs associated with the reconfigurable surface. In some examples, the CORESET manager 845 may be configured as or otherwise support a means for monitoring one or more search space sets associated with the one or more CORESETs, where receiving the one or more control messages is based on the monitoring.

In some examples, the RNTI manager 850 may be configured as or otherwise support a means for receiving control signaling indicating a first RNTI associated with a first type of control messages that indicate a single reflection parameter set, a second RNTI associated with a second type of control messages that indicate multiple reflection parameter sets, or both, where the one or more control messages are each associated with one of the first type of control messages or the second type of control messages.

In some examples, the RNTI manager 850 may be configured as or otherwise support a means for receiving control signaling indicating a RNTI associated with both a first type of control messages that indicate a single reflection parameter set, and a second type of control messages that indicate multiple reflection parameter sets, where each of the one or more control messages indicate whether the respective control message is associated with the first type of control messages or the second type of control messages.

In some examples, the reflection manager 835 may be configured as or otherwise support a means for reflecting the first signal from the first network entity to a first wireless device using the first reflection parameter set. In some examples, the reflection manager 835 may be configured as or otherwise support a means for reflecting the second signal from the second network entity to the first wireless device, a second wireless device, or both, using the second reflection parameter set.

In some examples, the reconfigurable surface includes a set of multiple reflective surface elements. In some examples, each of the first reflection parameter set and the second reflection parameter set includes a set of multiple precoders, a set of multiple reflection coefficients, or both, associated with at least a subset of the set of multiple reflective surface elements.

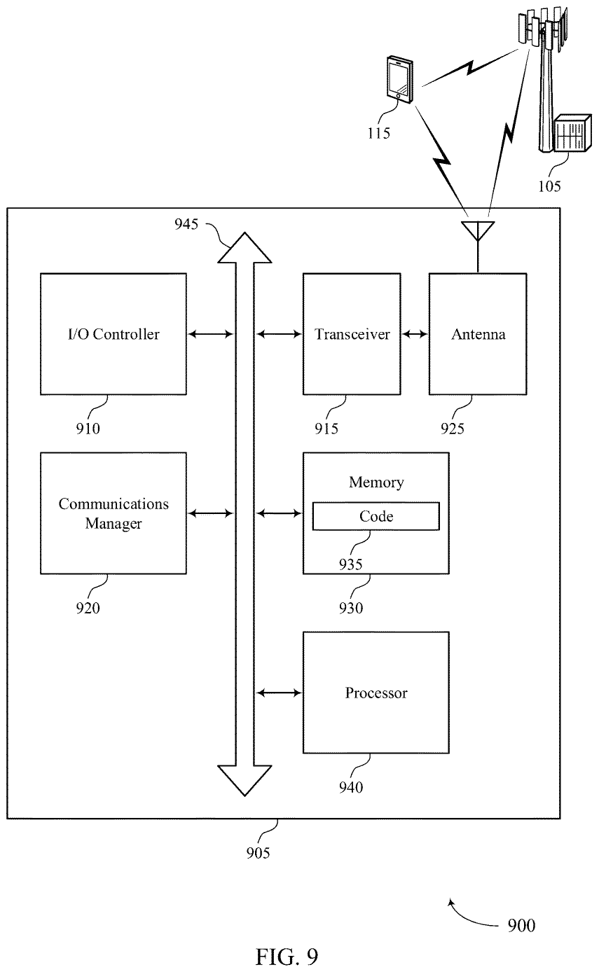

FIG. 9 illustrates a diagram of a system 900 including a device 905 that supports techniques for sharing RISs among multiple TRPs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROIDR, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for sharing RISs among multiple TRPs). For example, the device 905 or a component of the device 905 may include a processor 940 and memory 930 coupled with or to the processor 940, the processor 940 and memory 930 configured to perform various functions described herein.

For example, the communications manager 920 may be configured as or otherwise support a means for transmitting capability information indicating a capability of the reconfigurable surface to reflect a set of multiple signals during overlapping time intervals in accordance with a corresponding set of multiple different reflection parameter sets. The communications manager 920 may be configured as or otherwise support a means for receiving, based on the capability information, one or more control messages indicating at least a first reflection parameter set and a second reflection parameter set for reflecting signals received from a first TRP and a second TRP, respectively, during overlapping time intervals. The communications manager 920 may be configured as or otherwise support a means for reflecting a first signal received from the first TRP within a first time interval using the first reflection parameter set. The communications manager 920 may be configured as or otherwise support a means for reflecting a second signal received from the second TRP within a second time interval that at least partially overlaps with the first time interval using the second reflection parameter set.

By including or configuring the communications manager 920 in accordance with examples as described herein, the device 905 may support techniques that enable RISs to simultaneously relay signals received from multiple TRPs in accordance with different reflection configurations. Accordingly, aspects of the present disclosure may be used to increase coverage and throughput associated with TRPs within a network, thereby leading to more efficient and reliable wireless communications. Moreover, techniques described herein may enable multiple TRPs to utilize a single RIS at the same time, thereby leading to more efficient and widespread use of RIS to further circumvent obstructions and improve data throughput.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for sharing RISs among multiple TRPs as described herein, or the processor 940 and the memory 930 may be otherwise configured to perform or support such operations.

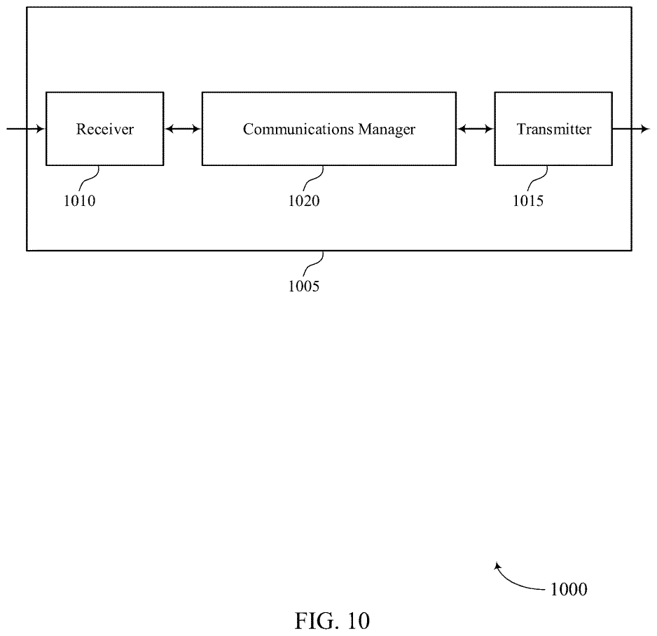

FIG. 10 illustrates a block diagram 1000 of a device 1005 that supports techniques for sharing RISs among multiple TRPs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for sharing RISs among multiple TRPs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 may be configured as or otherwise support a means for receiving, from a reconfigurable surface, capability information indicating a capability of the reconfigurable surface to reflect a set of multiple signals during overlapping time intervals in accordance with a corresponding set of multiple different reflection parameter sets. The communications manager 1020 may be configured as or otherwise support a means for transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP. The communications manager 1020 may be configured as or otherwise support a means for transmitting, to the reconfigurable surface, at least a first signal for reflection by the reconfigurable surface to a wireless device within the first time interval in accordance with the first reflection parameter set.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques that enable RISs to simultaneously relay signals received from multiple TRPs in accordance with different reflection configurations. Accordingly, aspects of the present disclosure may be used to increase coverage and throughput associated with TRPs within a network, thereby leading to more efficient and reliable wireless communications. Moreover, techniques described herein may enable multiple TRPs to utilize a single RIS at the same time, thereby leading to more efficient and widespread use of RIS to further circumvent obstructions and improve data throughput.

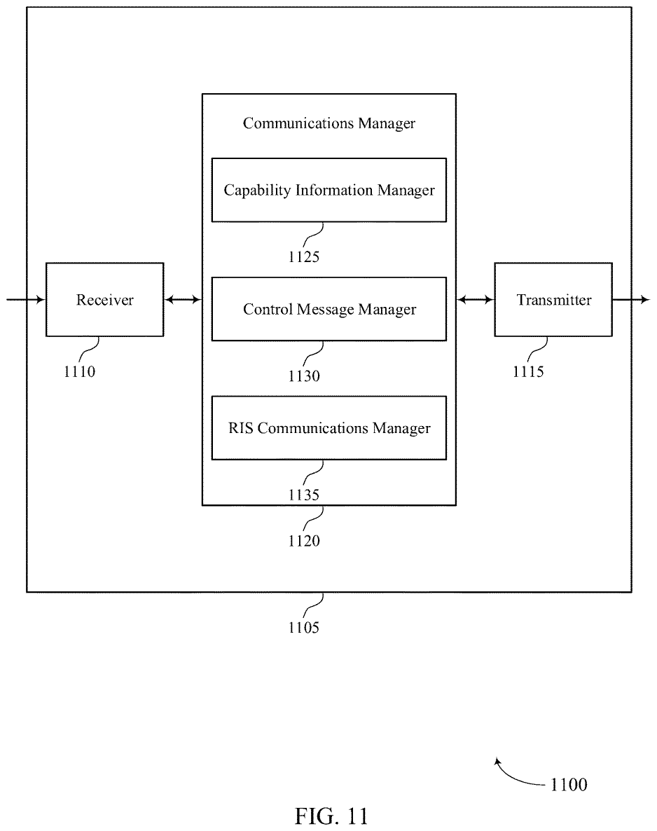

FIG. 11 illustrates a block diagram 1100 of a device 1105 that supports techniques for sharing RISs among multiple TRPs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for sharing RISs among multiple TRPs as described herein. For example, the communications manager 1120 may include a capability information manager 1125, a control message manager 1130, a RIS communications manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The capability information manager 1125 may be configured as or otherwise support a means for receiving, from a reconfigurable surface, capability information indicating a capability of the reconfigurable surface to reflect a set of multiple signals during overlapping time intervals in accordance with a corresponding set of multiple different reflection parameter sets. The control message manager 1130 may be configured as or otherwise support a means for transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP. The RIS communications manager 1135 may be configured as or otherwise support a means for transmitting, to the reconfigurable surface, at least a first signal for reflection by the reconfigurable surface to a wireless device within the first time interval in accordance with the first reflection parameter set.

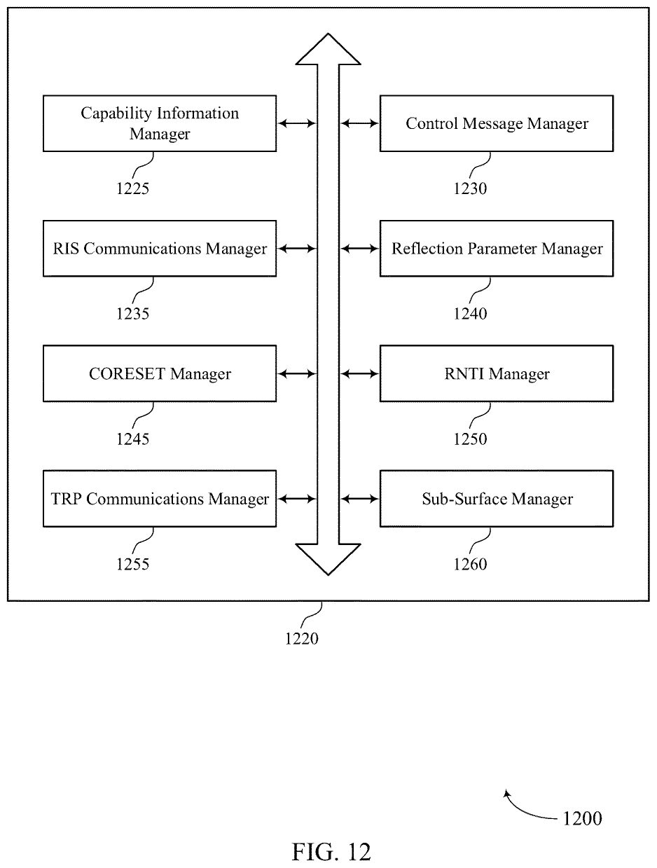

FIG. 12 illustrates a block diagram 1200 of a communications manager 1220 that supports techniques for sharing RISs among multiple TRPs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for sharing RISs among multiple TRPs as described herein. For example, the communications manager 1220 may include a capability information manager 1225, a control message manager 1230, a RIS communications manager 1235, a reflection parameter manager 1240, a CORESET manager 1245, an RNTI manager 1250, an TRP communications manager 1255, a sub-surface manager 1260, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The capability information manager 1225 may be configured as or otherwise support a means for receiving, from a reconfigurable surface, capability information indicating a capability of the reconfigurable surface to reflect a set of multiple signals during overlapping time intervals in accordance with a corresponding set of multiple different reflection parameter sets. The control message manager 1230 may be configured as or otherwise support a means for transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP. The RIS communications manager 1235 may be configured as or otherwise support a means for transmitting, to the reconfigurable surface, at least a first signal for reflection by the reconfigurable surface to a wireless device within the first time interval in accordance with the first reflection parameter set.

In some examples, to support transmitting the one or more control messages, the reflection parameter manager 1240 may be configured as or otherwise support a means for transmitting a single DCI message to the reconfigurable surface, where the single DCI message indicates the first reflection parameter set and not the second reflection parameter set, and where transmitting the first signal is based on transmitting the single DCI message.

In some examples, to support transmitting the one or more control messages, the reflection parameter manager 1240 may be configured as or otherwise support a means for transmitting, to the reconfigurable surface, a first DCI message indicating the first reflection parameter set, where transmitting the first signal is based on transmitting the first DCI message. In some examples, to support transmitting the one or more control messages, the reflection parameter manager 1240 may be configured as or otherwise support a means for transmitting, to the reconfigurable surface, a second DCI message indicating the second reflection parameter set.

In some examples, the reflection parameter manager 1240 may be configured as or otherwise support a means for transmitting, to the reconfigurable surface, control signaling indicating a maximum quantity of reflection parameter sets configurable at the reconfigurable surface for a single time interval, where the control signaling is transmitted based on the capability information.

In some examples, the reflection parameter manager 1240 may be configured as or otherwise support a means for transmitting control signaling indicating a set of multiple reflection parameter set identifiers associated with a set of multiple candidate reflection parameter sets, where the one or more control messages indicate a subset of the set of multiple reflection parameter set identifiers corresponding to the first reflection parameter set and the second reflection parameter set included within the set of multiple candidate reflection parameter sets.

In some examples, the control message manager 1230 may be configured as or otherwise support a means for transmitting, via the one or more control messages, an indication of a first set of resources associated with the first reflection parameter set, where the first time interval is associated with the first set of resources.

In some examples, the capability information manager 1225 may be configured as or otherwise support a means for receiving, via the capability information, an indication of a maximum quantity of reflection parameter sets supported by the reconfigurable surface during overlapping time intervals, where transmitting the one or more control messages is based on the indication of the maximum quantity of reflection parameter sets.

In some examples, the capability information manager 1225 may be configured as or otherwise support a means for receiving, via the capability information, an indication of a set of multiple sub-surfaces associated with the reconfigurable surface, where each sub-surface of the set of multiple sub-surfaces is configured to support a respective reflection parameter set during overlapping time intervals, where transmitting the one or more control messages is based on the indication of the set of multiple sub-surfaces.

In some examples, the sub-surface manager 1260 may be configured as or otherwise support a means for transmitting, via the one or more control messages, an indication of a first sub-surface of the set of multiple sub-surfaces associated with the first reflection parameter set.

In some examples, the reflection parameter manager 1240 may be configured as or otherwise support a means for transmitting, via control signaling, the one or more control messages, or both, a first set of one or more parameters associated with the first reflection parameter set, where the first set of one or more parameters includes a CRI, a reflection codeword index, a reflection coefficient, a pair of incident and reflective direction angles, or any combination thereof.

In some examples, the CORESET manager 1245 may be configured as or otherwise support a means for transmitting control signaling indicating one or more CORESETs associated with the reconfigurable surface, where the one or more control messages are associated with the one or more CORESETs.

In some examples, the RNTI manager 1250 may be configured as or otherwise support a means for transmitting control signaling indicating a first RNTI associated with a first type of control messages that indicate a single reflection parameter set, a second RNTI associated with a second type of control messages that indicate multiple reflection parameter sets, or both, where the one or more control messages are each associated with one of the first type of control messages or the second type of control messages.

In some examples, the RNTI manager 1250 may be configured as or otherwise support a means for transmitting control signaling indicating a RNTI associated with both a first type of control messages that indicate a single reflection parameter set, and a second type of control messages that indicate multiple reflection parameter sets, where each of the one or more control messages indicate whether the respective control message is associated with the first type of control messages or the second type of control messages.

In some examples, the reconfigurable surface includes a set of multiple reflective surface elements. In some examples, the first reflection parameter set includes a set of multiple precoders, a set of multiple reflection coefficients, or both, associated with at least a subset of the set of multiple reflective surface elements.

In some examples, the RIS communications manager 1235 may be configured as or otherwise support a means for receiving, from the second TRP, a message indicating the second reflection parameter set. In some examples, the RIS communications manager 1235 may be configured as or otherwise support a means for transmitting, via the one or more control messages, an indication of the second reflection parameter set.

In some examples, the TRP communications manager 1255 may be configured as or otherwise support a means for transmitting, to the second TRP, a message indicating one or more RNTIs associated with control messages that indicate reflection parameter sets to the reconfigurable surface, where the one or more control messages are associated with the one or more RNTIs.

In some examples, the TRP communications manager 1255 may be configured as or otherwise support a means for receiving, from the second TRP, a control message indicating one or more CORESETs associated with control messages communicated from the second TRP to the reconfigurable surface. In some examples, the RIS communications manager 1235 may be configured as or otherwise support a means for transmitting, to the reconfigurable surface via control signaling, the one or more control messages, or both, an indication of the one or more CORESETs.

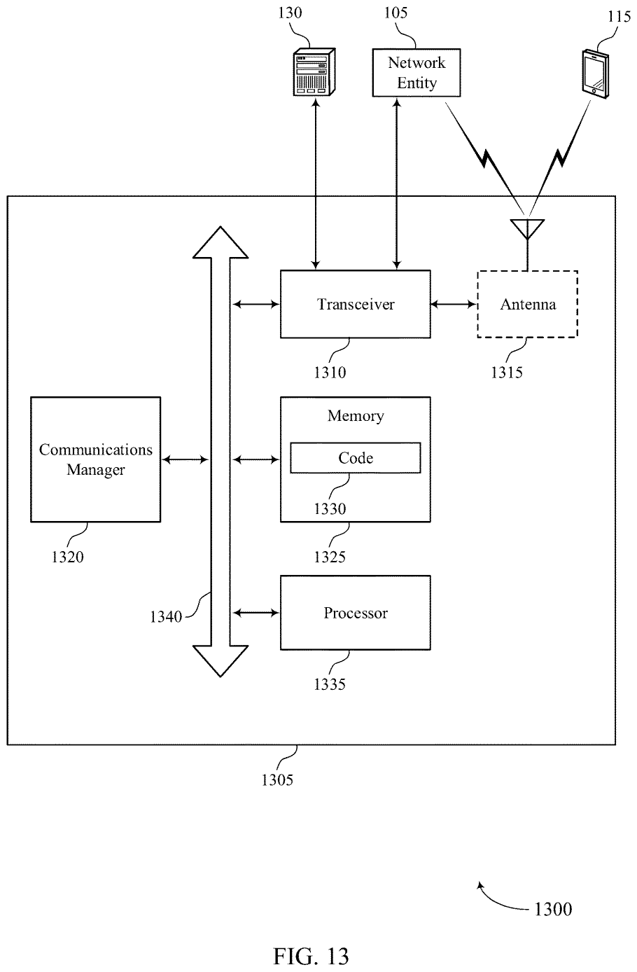

FIG. 13 illustrates a diagram of a system 1300 including a device 1305 that supports techniques for sharing RISs among multiple TRPs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for sharing RISs among multiple TRPs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 may be configured as or otherwise support a means for receiving, from a reconfigurable surface, capability information indicating a capability of the reconfigurable surface to reflect a set of multiple signals during overlapping time intervals in accordance with a corresponding set of multiple different reflection parameter sets. The communications manager 1320 may be configured as or otherwise support a means for transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP. The communications manager 1320 may be configured as or otherwise support a means for transmitting, to the reconfigurable surface, at least a first signal for reflection by the reconfigurable surface to a wireless device within the first time interval in accordance with the first reflection parameter set.

By including or configuring the communications manager 1320 in accordance with examples as described herein, the device 1305 may support techniques that enable RISs to simultaneously relay signals received from multiple TRPs in accordance with different reflection configurations. Accordingly, aspects of the present disclosure may be used to increase coverage and throughput associated with TRPs within a network, thereby leading to more efficient and reliable wireless communications. Moreover, techniques described herein may enable multiple TRPs to utilize a single RIS at the same time, thereby leading to more efficient and widespread use of RIS to further circumvent obstructions and improve data throughput.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for sharing RISs among multiple TRPs as described herein, or the processor 1335 and the memory 1325 may be otherwise configured to perform or support such operations.

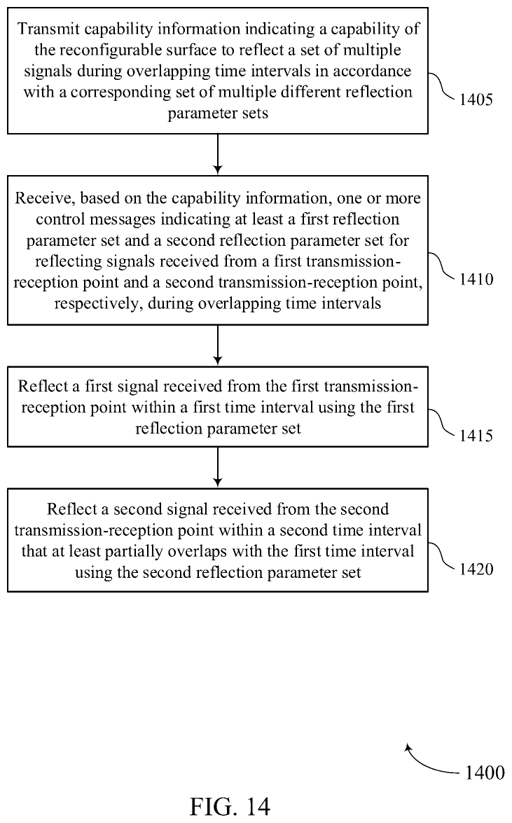

FIG. 14 illustrates a flowchart showing a method 1400 that supports techniques for sharing RISs among multiple TRPs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting capability information indicating a capability of the reconfigurable surface to reflect a set of multiple signals during overlapping time intervals in accordance with a corresponding set of multiple different reflection parameter sets. The operations of 1405 may be performed in accordance with examples as disclosed herein. In some examples, aspects of the operations of 1405 may be performed by a capability information manager 825 as described with reference to FIG. 8.

At 1410, the method may include receiving, based on the capability information, one or more control messages indicating at least a first reflection parameter set and a second reflection parameter set for reflecting signals received from a first TRP and a second TRP, respectively, during overlapping time intervals. The operations of 1410 may be performed in accordance with examples as disclosed herein. In some examples, aspects of the operations of 1410 may be performed by a control message manager 830 as described with reference to FIG. 8.

At 1415, the method may include reflecting a first signal received from the first TRP within a first time interval using the first reflection parameter set. The operations of 1415 may be performed in accordance with examples as disclosed herein. In some examples, aspects of the operations of 1415 may be performed by a reflection manager 835 as described with reference to FIG. 8.

At 1420, the method may include reflecting a second signal received from the second TRP within a second time interval that at least partially overlaps with the first time interval using the second reflection parameter set. The operations of 1420 may be performed in accordance with examples as disclosed herein. In some examples, aspects of the operations of 1420 may be performed by a reflection manager 835 as described with reference to FIG. 8.

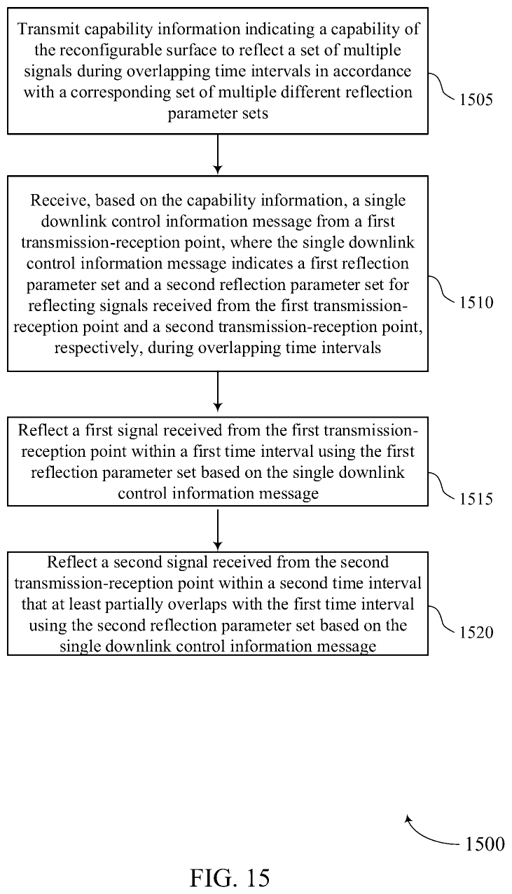

FIG. 15 illustrates a flowchart showing a method 1500 that supports techniques for sharing RISs among multiple TRPs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting capability information indicating a capability of the reconfigurable surface to reflect a set of multiple signals during overlapping time intervals in accordance with a corresponding set of multiple different reflection parameter sets. The operations of 1505 may be performed in accordance with examples as disclosed herein. In some examples, aspects of the operations of 1505 may be performed by a capability information manager 825 as described with reference to FIG. 8.

At 1510, the method may include receiving, based on the capability information, a single DCI message from a first TRP, where the single DCI message indicates a first reflection parameter set and a second reflection parameter set for reflecting signals received from the first TRP and a second TRP, respectively, during overlapping time intervals. The operations of 1510 may be performed in accordance with examples as disclosed herein. In some examples, aspects of the operations of 1510 may be performed by a reflection parameter manager 840 as described with reference to FIG. 8.

At 1515, the method may include reflecting a first signal received from the first TRP within a first time interval using the first reflection parameter set based on the single DCI message. The operations of 1515 may be performed in accordance with examples as disclosed herein. In some examples, aspects of the operations of 1515 may be performed by a reflection manager 835 as described with reference to FIG. 8.

At 1520, the method may include reflecting a second signal received from the second TRP within a second time interval that at least partially overlaps with the first time interval using the second reflection parameter set based on the single DCI message. The operations of 1520 may be performed in accordance with examples as disclosed herein. In some examples, aspects of the operations of 1520 may be performed by a reflection manager 835 as described with reference to FIG. 8.

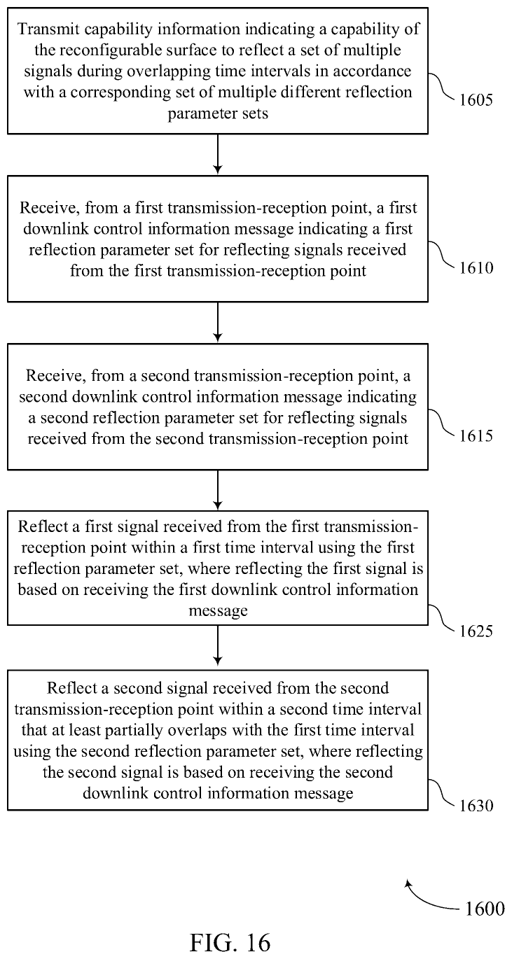

FIG. 16 illustrates a flowchart showing a method 1600 that supports techniques for sharing RISs among multiple TRPs in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting capability information indicating a capability of the reconfigurable surface to reflect a set of multiple signals during overlapping time intervals in accordance with a corresponding set of multiple different reflection parameter sets. The operations of 1605 may be performed in accordance with examples as disclosed herein. In some examples, aspects of the operations of 1605 may be performed by a capability information manager 825 as described with reference to FIG. 8.

At 1610, the method may include receiving, from a first TRP, a first DCI message indicating a first reflection parameter set for reflecting signals received from the first TRP, where reflecting the first signal is based on receiving the first DCI message. The operations of 1610 may be performed in accordance with examples as disclosed herein. In some examples, aspects of the operations of 1610 may be performed by a reflection parameter manager 840 as described with reference to FIG. 8.

At 1615, the method may include receiving, from a second TRP, a second DCI message indicating a second reflection parameter set for reflecting signals received from the second TRP. The operations of 1615 may be performed in accordance with examples as disclosed herein. In some examples, aspects of the operations of 1615 may be performed by a reflection parameter manager 840 as described with reference to FIG. 8.

At 1620, the method may include receiving, based on the capability information, one or more control messages indicating at least a first reflection parameter set and a second reflection parameter set for reflecting signals received from a first TRP and a second TRP, respectively, during overlapping time intervals. The operations of 1620 may be performed in accordance with examples as disclosed herein. In some examples, aspects of the operations of 1620 may be performed by a control message manager 830 as described with reference to FIG. 8.

At 1625, the method may include reflecting a first signal received from the first TRP within a first time interval using the first reflection parameter set, where reflecting the first signal is based on receiving the first DCI message. The operations of 1625 may be performed in accordance with examples as disclosed herein. In some examples, aspects of the operations of 1625 may be performed by a reflection manager 835 as described with reference to FIG. 8.

At 1630, the method may include reflecting a second signal received from the second TRP within a second time interval that at least partially overlaps with the first time interval using the second reflection parameter set, where reflecting the second signal is based on receiving the second DCI message. The operations of 1630 may be performed in accordance with examples as disclosed herein. In some examples, aspects of the operations of 1630 may be performed by a reflection manager 835 as described with reference to FIG. 8.

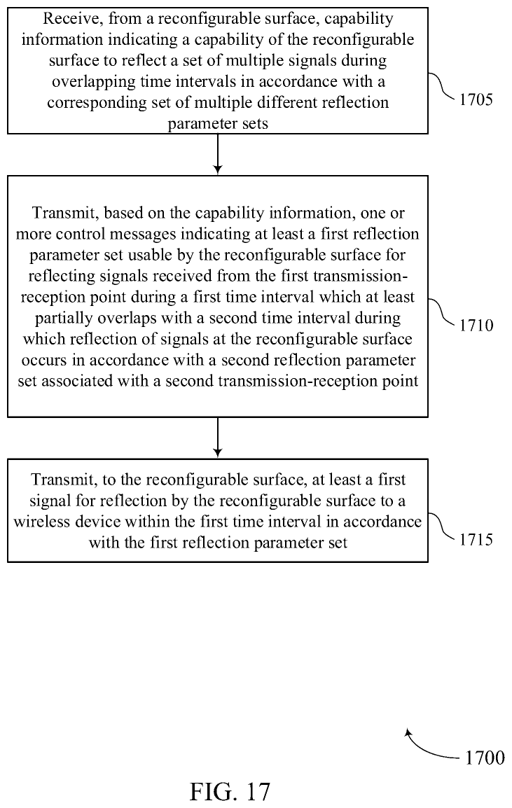

FIG. 17 illustrates a flowchart showing a method 1700 that supports techniques for sharing RISs among multiple TRPs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving, from a reconfigurable surface, capability information indicating a capability of the reconfigurable surface to reflect a set of multiple signals during overlapping time intervals in accordance with a corresponding set of multiple different reflection parameter sets. The operations of 1705 may be performed in accordance with examples as disclosed herein. In some examples, aspects of the operations of 1705 may be performed by a capability information manager 1225 as described with reference to FIG. 12.

At 1710, the method may include transmitting, based on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP. The operations of 1710 may be performed in accordance with examples as disclosed herein. In some examples, aspects of the operations of 1710 may be performed by a control message manager 1230 as described with reference to FIG. 12.

At 1715, the method may include transmitting, to the reconfigurable surface, at least a first signal for reflection by the reconfigurable surface to a wireless device within the first time interval in accordance with the first reflection parameter set. The operations of 1715 may be performed in accordance with examples as disclosed herein. In some examples, aspects of the operations of 1715 may be performed by a RIS communications manager 1235 as described with reference to FIG. 12.

The following provides an overview of aspects of the present disclosure:

Aspect 1: A method for wireless communication at a reconfigurable surface, comprising: transmitting capability information indicating a capability of the reconfigurable surface to reflect a plurality of signals during overlapping time intervals in accordance with a corresponding plurality of different reflection parameter sets; receiving, based at least in part on the capability information, one or more control messages indicating at least a first reflection parameter set and a second reflection parameter set for reflecting signals received from a first TRP and a second TRP, respectively, during overlapping time intervals; reflecting a first signal received from the first TRP within a first time interval using the first reflection parameter set; and reflecting a second signal received from the second TRP within a second time interval that at least partially overlaps with the first time interval using the second reflection parameter set.

Aspect 2: The method of aspect 1, wherein receiving the one or more control messages comprises: receiving a single DCI message from the first TRP or the second TRP, wherein the single DCI message indicates the at least the first reflection parameter set and the second reflection parameter set, and wherein reflecting the first signal and the second signal is based at least in part on receiving the single DCI message.

Aspect 3: The method of any of aspects 1 through 2, wherein receiving the one or more control messages comprises: receiving, from the first TRP, a first DCI message indicating the first reflection parameter set, wherein reflecting the first signal is based at least in part on receiving the first DCI message; and receiving, from the second TRP, a second DCI message indicating the second reflection parameter set wherein reflecting the second signal is based at least in part on receiving the second DCI message.

Aspect 4: The method of any of aspects 1 through 3, further comprising: receiving control signaling indicating a maximum quantity of reflection parameter sets configurable at the reconfigurable surface for a single time interval, wherein the control signaling is received based at least in part on the capability information.

Aspect 5: The method of any of aspects 1 through 4, further comprising: receiving control signaling indicating a plurality of reflection parameter set identifiers associated with a plurality of candidate reflection parameter sets, wherein the one or more control messages indicate a subset of the plurality of reflection parameter set identifiers corresponding to at least the first reflection parameter set and the second reflection parameter set included within the plurality of candidate reflection parameter sets.

Aspect 6: The method of any of aspects 1 through 5, further comprising: receiving, via the one or more control messages, an indication of a first set of resources associated with the first reflection parameter set and an indication of a second set of resources associated with the second reflection parameter set, wherein the first time interval and the second time interval are associated with the first set of resources and the second set of resources, respectively.

Aspect 7: The method of any of aspects 1 through 6, further comprising: transmitting, via the capability information, an indication of a maximum quantity of reflection parameter sets supported by the reconfigurable surface during overlapping time intervals, wherein receiving the one or more control messages is based at least in part on the indication of the maximum quantity of reflection parameter sets.

Aspect 8: The method of any of aspects 1 through 7, further comprising: transmitting, via the capability information, an indication of a plurality of sub-surfaces associated with the reconfigurable surface, wherein each sub-surface of the plurality of sub-surfaces is configured to support a respective reflection parameter set during overlapping time intervals, wherein receiving the one or more control messages is based at least in part on the indication of the plurality of sub-surfaces.

Aspect 9: The method of aspect 8, further comprising: receiving, via the one or more control messages, an indication of a first sub-surface and a second sub-surface of the plurality of sub-surfaces associated with the first reflection parameter set and the second reflection parameter set, respectively, wherein the first signal is reflected using the first sub-surface, and wherein the second signal is reflected using the second sub-surface.

Aspect 10: The method of any of aspects 1 through 9, further comprising: receiving, via control signaling, the one or more control messages, or both, a first set of one or more parameters associated with the first reflection parameter set and a second set of one or more parameters associated with the second reflection parameter set, wherein the first signal and the second signal are reflected based at least in part on the first set of one or more parameters and the second set of one or more parameters, respectively, wherein the first set of one or more parameters, the second set of one or more parameters, or both, comprise a CSI-RS resource identifier, a reflection codeword index, a reflection coefficient, a pair of incident and reflective direction angles, or any combination thereof.

Aspect 11: The method of any of aspects 1 through 10, further comprising: receiving control signaling indicating one or more CORESETs associated with the reconfigurable surface; and monitoring one or more search space sets associated with the one or more CORESETs, wherein receiving the one or more control messages is based at least in part on the monitoring.

Aspect 12: The method of any of aspects 1 through 11, further comprising: receiving control signaling indicating a first RNTI associated with a first type of control messages that indicate a single reflection parameter set, a second RNTI associated with a second type of control messages that indicate multiple reflection parameter sets, or both, wherein the one or more control messages are each associated with one of the first type of control messages or the second type of control messages.

Aspect 13: The method of any of aspects 1 through 12, further comprising: receiving control signaling indicating a RNTI associated with both a first type of control messages that indicate a single reflection parameter set, and a second type of control messages that indicate multiple reflection parameter sets, wherein each of the one or more control messages indicate whether the respective control message is associated with the first type of control messages or the second type of control messages.

Aspect 14: The method of any of aspects 1 through 13, wherein the first TRP comprises a first network entity, and wherein the second TRP comprises a second network entity, the method further comprising: reflecting the first signal from the first network entity to a first wireless device using the first reflection parameter set; and reflecting the second signal from the second network entity to the first wireless device, a second wireless device, or both, using the second reflection parameter set.

Aspect 15: The method of any of aspects 1 through 14, wherein the reconfigurable surface comprises a plurality of reflective surface elements, and each of the first reflection parameter set and the second reflection parameter set comprises a plurality of precoders, a plurality of reflection coefficients, or both, associated with at least a subset of the plurality of reflective surface elements.

Aspect 16: A method for wireless communication at a first TRP, comprising: receiving, from a reconfigurable surface, capability information indicating a capability of the reconfigurable surface to reflect a plurality of signals during overlapping time intervals in accordance with a corresponding plurality of different reflection parameter sets; transmitting, based at least in part on the capability information, one or more control messages indicating at least a first reflection parameter set usable by the reconfigurable surface for reflecting signals received from the first TRP during a first time interval which at least partially overlaps with a second time interval during which reflection of signals at the reconfigurable surface occurs in accordance with a second reflection parameter set associated with a second TRP; and transmitting, to the reconfigurable surface, at least a first signal for reflection by the reconfigurable surface to a wireless device within the first time interval in accordance with the first reflection parameter set.

Aspect 17: The method of aspect 16, wherein transmitting the one or more control messages comprises: transmitting a single DCI message to the reconfigurable surface, wherein the single DCI message indicates the first reflection parameter set and not the second reflection parameter set, and wherein transmitting the first signal is based at least in part on transmitting the single DCI message.

Aspect 18: The method of any of aspects 16 through 17, wherein transmitting the one or more control messages comprises: transmitting, to the reconfigurable surface, a first DCI message indicating the first reflection parameter set, wherein transmitting the first signal is based at least in part on transmitting the first DCI message; and transmitting, to the reconfigurable surface, a second DCI message indicating the second reflection parameter set.

Aspect 19: The method of any of aspects 16 through 18, further comprising: transmitting, to the reconfigurable surface, control signaling indicating a maximum quantity of reflection parameter sets configurable at the reconfigurable surface for a single time interval, wherein the control signaling is transmitted based at least in part on the capability information.

Aspect 20: The method of any of aspects 16 through 19, further comprising: transmitting control signaling indicating a plurality of reflection parameter set identifiers associated with a plurality of candidate reflection parameter sets, wherein the one or more control messages indicate a subset of the plurality of reflection parameter set identifiers corresponding to the first reflection parameter set and the second reflection parameter set included within the plurality of candidate reflection parameter sets.

Aspect 21: The method of any of aspects 16 through 20, further comprising: transmitting, via the one or more control messages, an indication of a first set of resources associated with the first reflection parameter set, wherein the first time interval is associated with the first set of resources.

Aspect 22: The method of any of aspects 16 through 21, further comprising: receiving, via the capability information, an indication of a maximum quantity of reflection parameter sets supported by the reconfigurable surface during overlapping time intervals, wherein transmitting the one or more control messages is based at least in part on the indication of the maximum quantity of reflection parameter sets.

Aspect 23: The method of any of aspects 16 through 22, further comprising: receiving, via the capability information, an indication of a plurality of sub-surfaces associated with the reconfigurable surface, wherein each sub-surface of the plurality of sub-surfaces is configured to support a respective reflection parameter set during overlapping time intervals, wherein transmitting the one or more control messages is based at least in part on the indication of the plurality of sub-surfaces.

Aspect 24: The method of aspect 23, further comprising: transmitting, via the one or more control messages, an indication of a first sub-surface of the plurality of sub-surfaces associated with the first reflection parameter set.

Aspect 25: The method of any of aspects 16 through 24, further comprising: transmitting, via control signaling, the one or more control messages, or both, a first set of one or more parameters associated with the first reflection parameter set, wherein the first set of one or more parameters comprises a CSI-RS resource identifier, a reflection codeword index, a reflection coefficient, a pair of incident and reflective direction angles, or any combination thereof.

Aspect 26: The method of any of aspects 16 through 25, further comprising: transmitting control signaling indicating one or more CORESETs associated with the reconfigurable surface, wherein the one or more control messages are associated with the one or more CORESETs.

Aspect 27: The method of any of aspects 16 through 26, further comprising: transmitting control signaling indicating a first RNTI associated with a first type of control messages that indicate a single reflection parameter set, a second RNTI associated with a second type of control messages that indicate multiple reflection parameter sets, or both, wherein the one or more control messages are each associated with one of the first type of control messages or the second type of control messages.

Aspect 28: The method of any of aspects 16 through 27, further comprising: transmitting control signaling indicating a RNTI associated with both a first type of control messages that indicate a single reflection parameter set, and a second type of control messages that indicate multiple reflection parameter sets, wherein each of the one or more control messages indicate whether the respective control message is associated with the first type of control messages or the second type of control messages.

Aspect 29: The method of any of aspects 16 through 28, wherein the reconfigurable surface comprises a plurality of reflective surface elements, and the first reflection parameter set comprises a plurality of precoders, a plurality of reflection coefficients, or both, associated with at least a subset of the plurality of reflective surface elements.

Aspect 30: The method of any of aspects 16 through 29, further comprising: receiving, from the second TRP, a message indicating the second reflection parameter set; and transmitting, via the one or more control messages, an indication of the second reflection parameter set.

Aspect 31: The method of any of aspects 16 through 30, further comprising: transmitting, to the second TRP, a message indicating one or more RNTIs associated with control messages that indicate reflection parameter sets to the reconfigurable surface, wherein the one or more control messages are associated with the one or more RNTIs.

Aspect 32: The method of any of aspects 16 through 31, further comprising: receiving, from the second TRP, a control message indicating one or more CORESETs associated with control messages communicated from the second TRP to the reconfigurable surface; and transmitting, to the reconfigurable surface via control signaling, the one or more control messages, or both, an indication of the one or more CORESETs.

Aspect 33: An apparatus comprising a processor; memory coupled with the processor; and instructions stored in the memory and executable by the processor to cause the apparatus to perform a method of any of aspects 1 through 15.

Aspect 34: An apparatus comprising at least one means for performing a method of any of aspects 1 through 15.

Aspect 35: A non-transitory computer-readable medium storing code the code comprising instructions executable by a processor to perform a method of any of aspects 1 through 15.

Aspect 36: An apparatus comprising a processor; memory coupled with the processor; and instructions stored in the memory and executable by the processor to cause the apparatus to perform a method of any of aspects 16 through 32.

Aspect 37: An apparatus comprising at least one means for performing a method of any of aspects 16 through 32.

Aspect 38: A non-transitory computer-readable medium storing code the code comprising instructions executable by a processor to perform a method of any of aspects 16 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a reconfigurable surface, comprising:
a processor,
memory coupled with the processor; and
instructions stored in the memory and executable by the processor to cause the apparatus to:
transmit capability information indicating a capability of the reconfigurable surface to reflect a plurality of signals during overlapping time intervals in accordance with a corresponding plurality of different reflection parameter sets,
receive, based at least in part on the capability information, one or more control messages indicating at least a first reflection parameter set and a second reflection parameter set for reflecting signals received from a first transmission-reception point and a second transmission-reception point, respectively, during overlapping time intervals;
reflect a first signal received from the first transmission-reception point within a first time interval using the first reflection parameter set; and
reflect a second signal received from the second transmission-reception point within a second time interval that at least partially overlaps with the first time interval using the second reflection parameter set.

2. The apparatus of claim 1, wherein the instructions to receive the one or more control messages are executable by the processor to cause the apparatus to:
receive a single downlink control information message from the first transmission-reception point or the second transmission-reception point, wherein the single downlink control information message indicates the at least the first reflection parameter set and the second reflection parameter set, and wherein reflecting the first signal and the second signal is based at least in part on receiving the single downlink control information message.

3. The apparatus of claim 1, wherein the instructions to receive the one or more control messages are executable by the processor to cause the apparatus to:
receive, from the first transmission-reception point, a first downlink control information message indicating the first reflection parameter set, wherein reflecting the first signal is based at least in part on receiving the first downlink control information message; and
receive, from the second transmission-reception point, a second downlink control information message indicating the second reflection parameter set wherein reflecting the second signal is based at least in part on receiving the second downlink control information message.

4. The apparatus of claim 1, wherein the instructions are further executable by the processor to cause the apparatus to:
receive control signaling indicating a maximum quantity of reflection parameter sets configurable at the reconfigurable surface for a single time interval, wherein the control signaling is received based at least in part on the capability information.

5. The apparatus of claim 1, wherein the instructions are further executable by the processor to cause the apparatus to:
receive control signaling indicating a plurality of reflection parameter set identifiers associated with a plurality of candidate reflection parameter sets, wherein the one or more control messages indicate a subset of the plurality of reflection parameter set identifiers corresponding to at least the first reflection parameter set and the second reflection parameter set included within the plurality of candidate reflection parameter sets.

6. The apparatus of claim 1, wherein the instructions are further executable by the processor to cause the apparatus to:
receive, via the one or more control messages, an indication of a first set of resources associated with the first reflection parameter set and an indication of a second set of resources associated with the second reflection parameter set, wherein the first time interval and the second time interval are associated with the first set of resources and the second set of resources, respectively.

7. The apparatus of claim 1, wherein the instructions are further executable by the processor to cause the apparatus to:
transmit, via the capability information, an indication of a maximum quantity of reflection parameter sets supported by the reconfigurable surface during overlapping time intervals, wherein receiving the one or more control messages is based at least in part on the indication of the maximum quantity of reflection parameter sets.

8. The apparatus of claim 1, wherein the instructions are further executable by the processor to cause the apparatus to:
transmit, via the capability information, an indication of a plurality of sub-surfaces associated with the reconfigurable surface, wherein each sub-surface of the plurality of sub-surfaces is configured to support a respective reflection parameter set during overlapping time intervals, wherein receiving the one or more control messages is based at least in part on the indication of the plurality of sub-surfaces.

9-10. (canceled)

11. The apparatus of claim 1, wherein the instructions are further executable by the processor to cause the apparatus to:
receive control signaling indicating one or more control resource sets associated with the reconfigurable surface; and
monitor one or more search space sets associated with the one or more control resource sets, wherein receiving the one or more control messages is based at least in part on the monitoring.

12. The apparatus of claim 1, wherein the instructions are further executable by the processor to cause the apparatus to:
receive control signaling indicating a first radio network temporary identifier associated with a first type of control messages that indicate a single reflection parameter set, a second radio network temporary identifier associated with a second type of control messages that indicate multiple reflection parameter sets, or both, wherein the one or more control messages are each associated with one of the first type of control messages or the second type of control messages.

13. The apparatus of claim 1, wherein the instructions are further executable by the processor to cause the apparatus to:
receive control signaling indicating a radio network temporary identifier associated with both a first type of control messages that indicate a single reflection parameter set, and a second type of control messages that indicate multiple reflection parameter sets, wherein each of the one or more control messages indicate whether the respective control message is associated with the first type of control messages or the second type of control messages.

14. (canceled)

15. The apparatus of claim 1, wherein the reconfigurable surface comprises a plurality of reflective surface elements, and wherein each of the first reflection parameter set and the second reflection parameter set comprises a plurality of precoders, a plurality of reflection coefficients, or both, associated with at least a subset of the plurality of reflective surface elements.

16. An apparatus for wireless communication at a first transmission-reception point, comprising:
a processor;
memory coupled with the processor; and
instructions stored in the memory and executable by the processor to cause the apparatus to:
receive, from a reconfigurable surface, capability information indicating a capability of the reconfigurable surface to reflect a plurality of signals during overlapping time intervals in accordance with a corresponding plurality of different reflection parameter sets;
transmit, based at least in part on the capability information, one or more control messages indicating at least a first reflection parameter set usable by the reconfigurable surface for reflecting signals received from the first transmission-reception point during a first time interval which at least partially overlaps with a second time interval during which reflection of signals at the reconfigurable surface occurs in accordance with a second reflection parameter set associated with a second transmission-reception point; and
transmit, to the reconfigurable surface, at least a first signal for reflection by the reconfigurable surface to a wireless device within the first time interval in accordance with the first reflection parameter set.

17. The apparatus of claim 16, wherein the instructions to transmit the one or more control messages are executable by the processor to cause the apparatus to:
transmit a single downlink control information message to the reconfigurable surface, wherein the single downlink control information message indicates the first reflection parameter set and not the second reflection parameter set, and wherein transmitting the first signal is based at least in part on transmitting the single downlink control information message.

18. The apparatus of claim 16, wherein the instructions to transmit the one or more control messages are executable by the processor to cause the apparatus to:
transmit, to the reconfigurable surface, a first downlink control information message indicating the first reflection parameter set, wherein transmitting the first signal is based at least in part on transmitting the first downlink control information message; and
transmit, to the reconfigurable surface, a second downlink control information message indicating the second reflection parameter set.

19. The apparatus of claim 16, wherein the instructions are further executable by the processor to cause the apparatus to:
transmit, to the reconfigurable surface, control signaling indicating a maximum quantity of reflection parameter sets configurable at the reconfigurable surface for a single time interval, wherein the control signaling is transmitted based at least in part on the capability information.

20. (canceled)

21. The apparatus of claim 16, wherein the instructions are further executable by the processor to cause the apparatus to:
transmit, via the one or more control messages, an indication of a first set of resources associated with the first reflection parameter set, wherein the first time interval is associated with the first set of resources.

22. The apparatus of claim 16, wherein the instructions are further executable by the processor to cause the apparatus to:
receive, via the capability information, an indication of a maximum quantity of reflection parameter sets supported by the reconfigurable surface during overlapping time intervals, wherein transmitting the one or more control messages is based at least in part on the indication of the maximum quantity of reflection parameter sets.

23-24. (canceled)

25. The apparatus of claim 16, wherein the instructions are further executable by the processor to cause the apparatus to:
transmit control signaling indicating one or more control resource sets associated with the reconfigurable surface, wherein the one or more control messages are associated with the one or more control resource sets.

26. The apparatus of claim 16, wherein the instructions are further executable by the processor to cause the apparatus to:
receive, from the second transmission-reception point, a message indicating the second reflection parameter set; and
transmit, via the one or more control messages, an indication of the second reflection parameter set.

27-30. (canceled)
